(19) United States
(12) Patent Application Publication
(10) Pub. No.: US 2019/0170502 A1
(43) Pub. Date: Jun. 6, 2019

(54) POSITION DESIGNATION DEVICE AND POSITION DESIGNATION METHOD

(71) Applicant: SHARP KABUSHIKI KAISHA, Sakai City, Osaka (JP)

(72) Inventors: TAKAYUKI TAMARU, Sakai City (JP); KEI TOKUI, Sakai City (JP)

(21) Appl. No.: 16/324,097

(22) PCT Filed: Aug. 8, 2017
(86) PCT No.: PCT/JP2017/028720

§ 371 Date: Feb. 7, 2019

(30) Foreign Application Priority Data
Aug. 9, 2016 (JP) 2016-156917

(51) Int. Cl. G01B 11/00; G01B 11/22; H04N 5/235; G06T 7/50; G06T 7/73; G06T 5/50

(52) U.S. Cl. CPC G01B 11/002; G01B 11/22; H04N 5/2355; H04N 5/2351; G06T 7/50; G06T 2207/20092; G06T 5/50; G06T 2207/20221; G06T 2207/10144; G06T 2207/10148; G06T 7/74

(57) ABSTRACT

Position designation technology is provided for designating a desired position for a measurement point. A position designation device includes: a first position receiving section configured to cause a display device to display a synthesized image and to receive an input of a first position in the synthesized image via an input device; an image selecting section configured to select one of the captured images in accordance with the first position as a selected image; and a second position receiving section configured to cause the display device to display at least a part of the selected image and to receive an input of a second position in the selected image via the input device.

### TECHNICAL FIELD

The present invention, in an aspect thereof, relates to position designation devices and position designation methods.

### BACKGROUND ART

There are known techniques for capturing deep depth-of-field images on camera. One of such techniques captures a plurality of images with different focal point location settings, selects suitable, well-focused pixels from across the captured images, and combine the selected pixels to generate a deep depth-of-field image.

Techniques are also known for capturing wide-dynamic-range images. One of such techniques captures a plurality of images with different exposure settings, selects suitable pixels having equal exposure levels from across the captured images, and combine the selected pixels to generate a wide-dynamic-range image.

As an example, Patent Literature 1 discloses a method of obtaining a natural-looking image with an improved dynamic range and less decaying from a plurality of input images having different exposure levels that are captured of the same subject.

### CITATION LIST

### Patent Literature

Patent Literature 1: Japanese Unexamined Patent plication Publication, Tokukai, No. 2012-165259 (Publication Date: Aug. 30, 2012).

### SUMMARY OF INVENTION

### Technical Problem

Recent development in measurement technology has enabled computation of three-dimensional information for a measurement point in a captured image. For example, a parallax is calculated from a plurality of images captured from different positions. In reference to information on these positions, three-dimensional information is calculated for any measurement point. In another known example, three-dimensional information is calculated for any measurement point in reference to depth information associated with captured images.

In these measurement techniques, the user, for example, checks a captured image displayed on a display device and designates the positions of measurement points in the captured image using an input device. In this process, grayscale saturation can occur in the image, for example, if the image is captured under conventional automatic exposure control. Grayscale saturation is especially likely in images with a wide angle of view. The captured image may have a shallow depth of field. In such cases, it will be difficult for the user to designate an intended position of a measurement point in parts of a captured linage where grayscale has saturated or in parts that are out of focus.

Grayscale saturation in a synthesized image can be restrained, for example, by applying the technology described in Patent Literature 1. According to the technology, the user may easily designate an intended position of a measurement point if the devise is configured to enable the user to designate the position of a measurement point in the synthesized image. The technology described in Patent Literature 1, however, necessitates complex image processing to obtain a synthesized image. It is therefore useful to develop, by means of a new configuration, position designation technology allowing for designation of a desired position of a measurement point.

The present invention, in an aspect thereof, has been made in view of these issues and has an object to provide position designation technology for designating a desired position for a measurement point.

### Solution to Problem

The present invention, in one aspect thereof, addresses these issues and is directed to a position designation device including: an image acquisition section configured to acquire a plurality of captured images of the same subject and a synthesized image generated from the captured images; a first position receiving section configured to cause a display device to display the synthesized image and to receive an input of a first position in the synthesized image via an input device; an image selecting section configured to select one of the captured images in accordance with the first position as a selected image; and a second position receiving section configured to cause the display device to display at least a part of the selected image and to receive an input of a second position in the selected image via the input device.

### Advantageous Effects of Invention

The present invention, in an aspect thereof advantageously enables designation of a desired position of a measurement point.

### BRIEF DESCRIPTION OF DRAWINGS

FIG. 1 is a block diagram of an example configuration of a position designation device in accordance with a first embodiment of the present invention.

FIG. 2 is a flow chart representing a process performed by a position designation device in accordance with some embodiments of the present invention.

FIG. 3 is an illustration showing example output images generated by a position designation device in accordance with the first embodiment of the present invention.

FIG. 4 is an illustration showing example output images generated by a position designation device in accordance with the first embodiment of the present invention.

FIG. 5 is graphs for a conversion from pixel values in image capturing to pixel values used for a display on a display device.

FIG. 6 is an illustration showing example output images generated by a position designation device in accordance with a second embodiment of the present invention.

FIG. 7 is a block diagram of an example configuration of a measuring instrument in accordance with a third embodiment of the present invention.

FIG. 8 is a flow chart representing a process performed by a measuring instrument in accordance with the third embodiment of the present invention.

FIG. 9 is a block diagram of an example configuration of a measuring instrument in accordance with a fourth embodiment of the present invention.

FIG. 10 is a flow chart representing a process performed by a measuring instrument in accordance with some embodiments of the present invention.

FIG. 11 is an illustration of a triangulation-based method.

FIG. 12 is a diagram depicting block matching.

FIG. 13 is a block diagram of an example configuration of a measuring instrument in accordance with a fifth embodiment of the present invention.

FIG. 14 is a block diagram of an example configuration of a synthesis processing section of an image capturing device in a measuring instrument in accordance with the fifth embodiment of the present invention.

FIG. 15 is a flow chart representing a process performed by the synthesis processing section.

FIG. 16 is a block diagram of an example configuration of a measuring instrument in accordance with a sixth embodiment of the present invention.

FIG. 17 is an illustration showing example output images generated by a measuring instrument in accordance with the sixth embodiment of the present invention.

FIG. 18 is a diagram representing example coefficients for edge-intensity-detecting filtering.

### DESCRIPTION OF EMBODIMENTS

### 1. Embodiment 1

The following will specifically describe a position designation device 1 in accordance with a first embodiment of the present invention in reference to drawings.

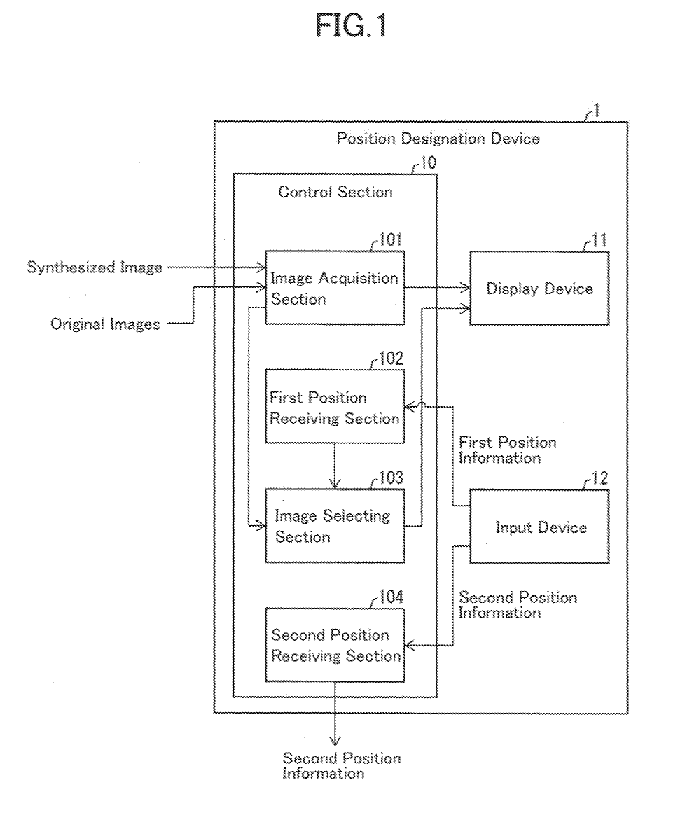

FIG. 1 is a block diagram of an example configuration of the position designation device 1 in accordance with the first embodiment of the present invention. Referring to FIG. 1, the position designation device 1 includes a control section 10, a display device 11, and an input device 12. The control section 10, the display device 11. and the input device 12 may be integrated into a single apparatus or provided separately.

The control section 10 controls the overall operation of the position designation device 1 and serves as an image acquisition section 101, a first position receiving section 102, an image selecting section 103, and a second position receiving section 104. The processes implemented by the control section 10 will be described later in detail.

The control section 10 a ay be, for example: a processing unit including a processor (not shown) such as a CPU (central processing unit) and a main storage device (not shown) such as a RAM (random access memory) to run a program stored in the storage device to carry out various processes; an FPGA (field programmable gate array) or like programmable integrated circuit, or any hardware including an integrated circuit that executes various processes.

The display device 11 may be, for example, a CRT, a liquid crystal display device, or an OLED (organic light-emitting diode) display device. The input device 12 may be, for example, a mouse, a pen tablet, or a touch panel.

### (1) General Description of Position Designation Device 1

The position designation device 1 acquires a plurality of captured images of the same subject (which hereinafter may be referred to simply as “captured images”) and a synthesized image generated from these captured images (which hereinafter may be referred to simply as a “synthesized image”). The position designation device I then causes the display device 11 to display the synthesized image and receives a designation of a position (first position) in the synthesized image from the user (operator) via the input device 12. Next, the position designation device 1 selects as a selected image one of the captured images in accordance with the received first position. Subsequently, the position designation device 1 causes the display device 11 to display at least a part of the selected image and receives a designation of a position (second position) in the selected image from the user via the input device 12. This configuration enables the user to designate a desired position for a measurement point in the captured image.

### (2) Example of Position Designation Process

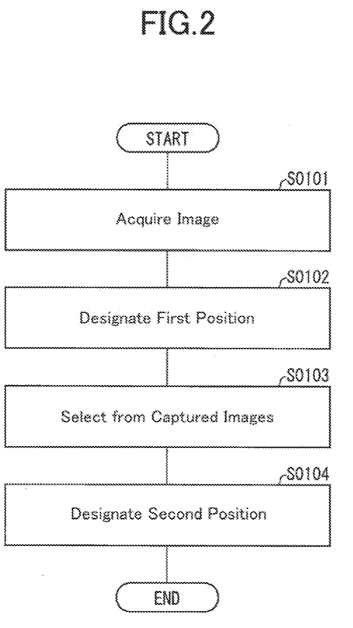

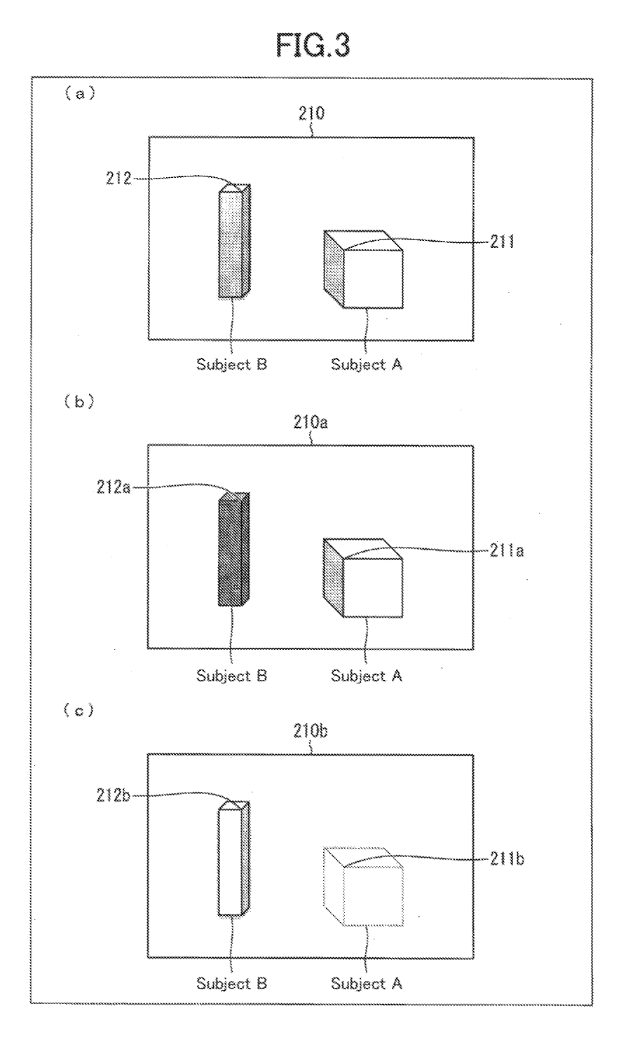

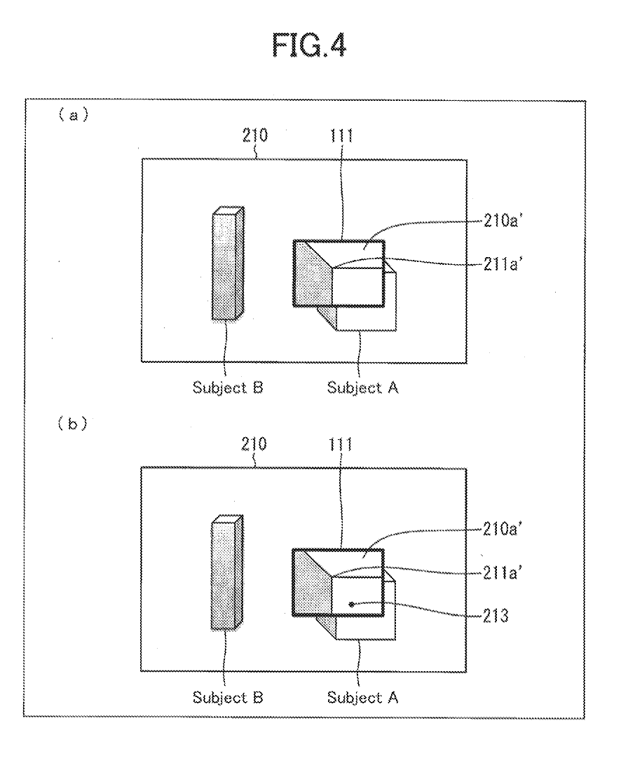

The following will describe an example position designation process performed by the position designation device 1 in reference to FIGS. 2 to 4. FIG. 2 is a flow chart representing a process performed by the position designation device 1 in accordance with the present embodiment. FIGS. 3 and 4 are illustrations showing example output images generated by the position designation device 1 in accordance with the present embodiment.

### Step S0101: Image Acquisition Step

The image acquisition section 101 in the position designation device 1 in accordance with the present embodiment acquires a plurality of captured images of the same subject and a synthesized image generated from these captured images.

The “plurality of captured images of the same subject” is not limited in any particular manner and may be, for example, a plurality of images of the same subject captured under different image capturing conditions. Examples of the “image capturing conditions” include an exposure level and/or a focal point location.

Throughout the present embodiment, the “plurality of captured images of the same subject” is a plurality of images of the same subject captured with different exposure settings, and the “synthesized image generated from captured images” is a synthesized image obtained by combining the plurality of captured images in such a manner as to extend the dynamic range of the resultant synthesized image. In an embodiment, the “synthesized image generated from captured images” may be an image in which each pixel has a pixel value averaged over the corresponding pixels of the captured images. Another method of generating a synthesized image with an extended dynamic range is to calculate a contrast difference in a predetermined area around each pixel in each captured image and select one of the captured images that has a maximum contrast difference for each area for use in synthesis.

The image acquisition section 101, in an aspect, may acquire a plurality of captured images and a synthesized image, for example, from an external image capturing device and an external image processing device over a wired or wireless link. Alternatively, the position designation device 1 may include an image capturing section and an image processing section so that the image acquisition section 101 can acquire a plurality of captured images and a synthesized image from the image capturing section and the image processing section.

### Step S0102: First Position Receiving Step

Next, the first position receiving section 102 causes the display device 11 to display the synthesized image and receives a designation of a position (first position) in the synthesized image from the user (operator) via the input device 12. For example, the user designates a position in the synthesized image displayed on the display device 11 as a first position by manually operating the input device 12 such as a mouse or a touch pad. In response to the designation of the position, the input device 12 outputs input information to the first position receiving section 102, and the first position receiving section 102 receives this input of a position (first position) in the synthesized image.

As shown in (a) of FIG. 3, a synthesized image 210 has an extended dynamic range and contains a subject A including a point 211 that is present in a bright region and a subject B including a point 212 that is present in a dark region without the grayscale reaching saturation. The user can therefore accurately recognize any position in the synthesized image displayed on the display device 11 and designate a desired position via the input device 12.

In contrast, (b) and (c) of FIG. 3 respectively represent a captured image 210a and a captured image 210b which are captured with different exposure settings. The captured images 210a and 210b in (b) and (c) of FIG. 3 correspond to the plurality of captured images that will be combined to generate the synthesized image 210 shown in (a) of FIG. 3. The captured image 210a shown in (b) of FIG. 3 is captured with a shorter exposure time setting than is the captured image 210b shown in (c) of FIG. 3.

In the captured image 210a shown in (b) of FIG. 3, the grayscale does not reach saturation in the area showing the subject A including a point 211a in a bright region. Meanwhile, the grayscale saturates in the area shoving the subject B including a point 212a where brightness is insufficient (the area displays black color). If the first position receiving section 102 causes the display device 11 to display the captured image 210a, the user can accurately recognize the position of the point 211a. But, because of the grayscale saturation, the user cannot accurately recognize the position of the point 212 and will have difficulty in appropriately designating the position of the point 212a.

The captured image 210b shown in (c) of FIG. 3 is captured with a longer exposure time setting than is the captured image 210a show in (b) of FIG. 3. The grayscale does not reach saturation in the area showing the subject B including a point 212b in a dark region. Meanwhile, the grayscale saturates in the area showing the subject A including a point 211b where brightness is excessive (the area displays white color). If the first position receiving section 102 causes the display device 11 to display the captured image 210b, the user can accurately recognize the position of the point 212b, but cannot accurately recognize the position of the point 211b because of the grayscale saturation. Hence, the user will have difficulty in appropriately designating the position of the point 211b.

For these reasons, by the first position receiving section 102 causing the display device 11 to display the synthesized image 210 as in (a) of FIG. 3, the user can easily find a desired position (first position) in the synthesized image 210 being displayed on the display device 11. The user can also designate both the position of the point 211 residing in a bright region and the position of the point 212 residing in a dark region in the same synthesized image 210.

The first position receiving section 102 may receive an input of a desired position for a point in the synthesized image 210 and may receive an input of a desired position for a region in the synthesized image 210.

The synthesized image 210 having an extended dynamic range is displayed in step S0102 for the designation of a position as described above. Captured images may include very bright and dark regions. The synthesized image 210 however has an extended dynamic range and is free from grayscale saturation. The user can therefore visually recognize the entire image easily and designate a position (first position) in the synthesized image 210 being displayed. For example, even when the user needs to designate a position in an image captured of a scenery with very bright and dark regions, the synthesized image 210 has an extended dynamic range and is free from grayscale saturation. The user can thus check both bright and dark regions in the same image. The synthesized image 210 is hence very suitable for the user to explore for a position that the user wants to designate. The user can also designate a position (first position) in both the bright and dark regions in the same synthesized image 210.

### Step S0103: image Selecting Step

Next, the image selecting section 103 selects, as a selected image, one of the captured images in accordance with the first position received in step S0102.

The image selecting section 103 may select an image, for example, by calculating the grayscale saturation level of a subarea including the first position for each captured image and selecting one of the captured images that has a minimum grayscale saturation level as a selected image. The “subarea including the first position” refers to a subarea of a captured image that includes a position (first-position-equivalent position) in the captured image corresponding to the first position. The size of the subarea is not limited in any particular manner and may be, for example, a rectangular region containing a predetermined number of pixels.

More specifically, as the first position receiving section 102 receives an input of the point 211 in the synthesized image 210 as the first position (see (a) of FIG. 3), the image selecting section 103 calculates the grayscale saturation level of a subarea of each captured image, the subarea including a point (corresponding point) that corresponds to the point 21 t in that captured image. As an example, the image selecting section 103 calculates the grayscale saturation level of a subarea of the captured image 210a, the subarea including the corresponding point 211a in the captured image 210a (see (b) of FIG. 3), and similarly calculates the gray scale saturation level of a subarea of the captured image 210b, the subarea including the corresponding point 2111 in the captured image 210b (see (c) of FIG. 3). The image selecting section 103 then selects one of the captured images that has a minimum grayscale saturation level as a selected image. The image selecting section 103, in the present embodiment, selects the captured image 210a as a selected image (see (b) of FIG. 3). The image selecting section 103 may store the selected image in a storage device.

The image selecting section 103, in an aspect, calculates the number of saturated pixels in the subarea as the “grayscale saturation level.” The image selecting section 103 determines that the grayscale saturation level of a subarea is lower if the subarea contains fewer saturated pixels. Accordingly, the “one of the captured images that has a minimum grayscale saturation level” is one of the captured images that has a subarea containing the least number of saturated pixels.

### Step S0104: Second Position Receiving Step

Next, the second position receiving section 104 causes the display device 11 to display at least a part of the captured image 210a as a selected image (namely, a selected image 210a) and receives a designation of a position (second position) in the selected image from the user via the input device 12.

The second position receiving section 104 may cause the display device 11 to display the whole selected image. Alternatively, the second position receiving section 104 may cause the display device 11 to display a part of the selected image (partial image) that includes the first-position-equivalent position. As another alternative, the second position receiving section 104 may cause the display device 11 to display a partial image at the original scale or at an enlarged scale. The second position receiving section 104 may further alternatively cause the display device 11 to display the selected image alone or the selected image being superimposed on a synthesized image. In the present embodiment, the second position receiving section 104 scales up a partial image including the corresponding point 211a in the captured image 210a serving as the selected image (namely, the selected image 210a′) and causes the display device 11 to display a resultant scaled-up display image 111 being superimposed on the synthesized image 210 as shown in (a) of FIG. 4.

The second position receiving section 104 then receives via the input device 12 an input of the position of a point 211a′ (second position) in the partial image of the selected image 210a′ displayed on the display device 11 as the scaled-up display image 111 (see (a) of FIG. 4). The captured image 210a (see (b) of FIG. 3) as the selected image 210a′ is free from grayscale saturation in a region around the corresponding point 211a. Therefore, the user can easily visually recognize a point that the user wants to designate. Additionally, when the second position receiving section 104 causes the display device 11 to display the selected image 210a′ at an enlarged scale, the user can easily check the position of a point that the user wants to designate and can also easily designate a point that the user wants to designate.

The corresponding point 211a in the captured image 210a does not necessarily have the same coordinates as the point 211a′ designated as the second position in the partial image of the selected image 210a′. The user may first designate in the synthesized image 210 an approximate position of a point that the user wants to designate as the first position and subsequently designate in the selected image 210a″ the accurate position of the point that the user wants to designate. In other words, since the corresponding point 211a in the captured image 210a represents an approximate position of a point that the user wants to designate, the point 211a′ designated as the second position in the partial image of the selected image 210a′ may have different coordinates from the coordinates of the corresponding point 211a in the captured image 210a, as a result of the user having confirmed the accurate position of the point that the user wants to designate by checking the selected image 210a′.

The position designation device can improve visibility for the user searching an image for a position that the user wants to designate, by displaying the entire synthesized image that has an extended dynamic range. Furthermore, the position designation device 1 can select a captured image that has a minimum grayscale saturation level as a selected image in accordance with the position (first position) designated by the user in the synthesized image, so that the user can designate a position (second position) in the selected image. Therefore, the user can accurately designate a position that the user wants to designate in an image.

If a plurality of images is captured of the same subject with different exposure settings in order to generate a synthesized image with a wide dynamic range, discrepancy occurs between the captured images because the images are captured at different times and the image capturing device or the subject may move during the image capturing period. The synthesized image generated from captured images that include discrepancy can therefore be double vision, which results in a failure to accurately designate the position of a measurement point. This problem may be addressed by a known technique disclosed, for example, in Patent Literature 1. The technique combines a plurality of images of the same subject captured with different exposure settings while preventing positional deviations, in order to acquire a high-quality synthesized image with no decays caused by positional deviations. Complex image processing is essential to acquire a high-quality synthesized image with no decays caused by positional deviations. As a result, if such a synthesized image is used to designate the position of a measurement point, complex image processing is needed to acquire a high-quality synthesized image. Therefore, the user cannot easily designate a desired position for a measurement point in an image.

In contrast, the position designation device 1 uses a synthesized image in such a manner that the user can explore the synthesized image for a desired position of a measurement point and designate a measurement point in an image selected in accordance with the position (first position) found by the user m the synthesized image. The position designation device 1 therefore does not need to acquire a high-quality synthesized image generated by considering the positional deviations of the subject. Even when the synthesized image is double vision, since the measurement point is designated in the selected image, the position designation device 1 is free from the problem that the position of a measurement point cannot be accurately designated in a double-vision synthesized image. In addition, since there occurs no grayscale saturation near the first position in the image selected in accordance with the position (first position) found in the synthesized image, it is possible to designate a position in the selected image. Hence, the position designation device 1 in accordance with the present embodiment enables the user to easily and accurately designate a desired position for a measurement point in an image.

### (3) Variation Example of Position Designation Device 1

### (i) Variation Example of Step S0103 (Image Selecting Step)

Step S0103 may further include the following substeps:

(a) a step in which the image selecting section 103 corrects the image selected in step S0103 under different correction conditions to obtain a plurality of corrected images (substep S01031, “image correction step”); and

(b) a step in which the image selecting section 103 selects, in accordance with the first position received in the first position receiving step, one of the corrected images obtained under different correction conditions as a selected image (substep S01032, “corrected image selecting step”).

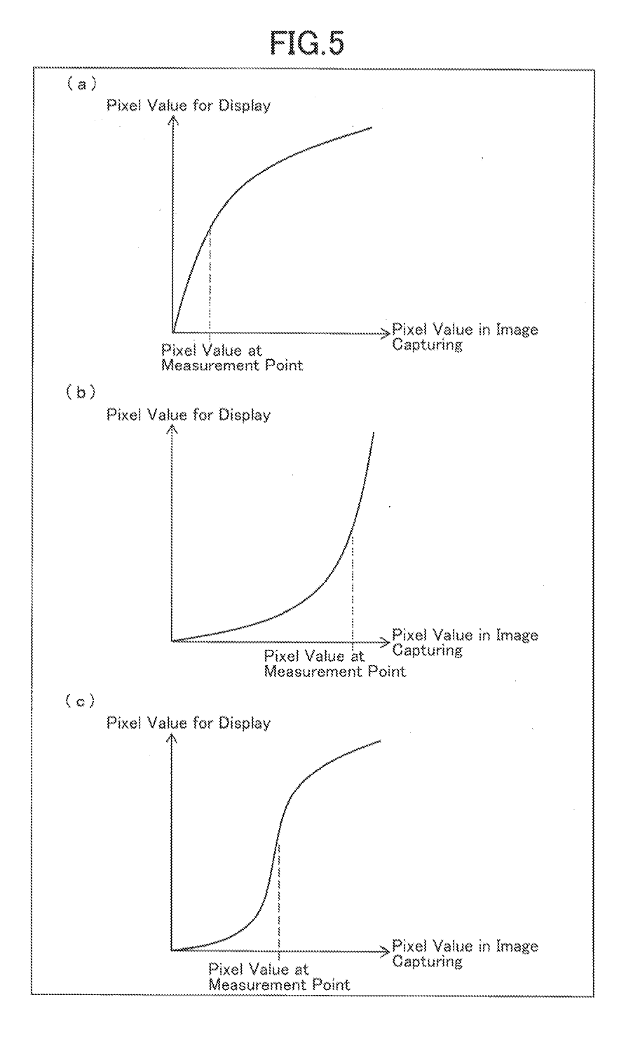

Correcting the contrast of a selected image advantageously improves visibility for the user. A description will be given of an example contrast correction method in reference to FIG. 5. Portion (a) of FIG. 5 is a graph for a conversion from pixel values in image capturing to pixel values used for a display on a display device to brighten the measurement point and its surroundings when the measurement point is in a dark region. Since the measurement point has a low pixel value and is dark, the conversion improves visibility by changing the pixel value of the measurement point appropriately to the middle value of the displayable range and also increasing contrast of the pixel values in the surroundings of the measurement point.

Portion (b) of FIG. 5 is a graph for a conversion from pixel values in image capturing to pixel values used for a display on a display device to darken the measurement point and its surroundings when the measurement point is in a bright region. Since the measurement point has a high pixel value and is bright, the conversion improves visibility by changing the pixel value of the measurement point appropriately to the middle value of the range and also increasing contrast in the surroundings of the measurement point.

Portion (c) of FIG. 5 is a graph for a conversion from pixel values in image capturing to pixel values used for a display on a display device to increase contrast when the measurement point and its surroundings have an intermediate brightness. These conversions can improve visibility for the user by correcting contrast in accordance with the pixel values of the surroundings of the measurement point.

Examples of the image correction in substep (a) include, in addition to contrast correction, gamma correction and saturation correction. As an example, if the corrected images Obtained in substep (a) are contrast-corrected images, for example, the image selecting section 103 may in substep (b) calculate a contrast difference in a subarea including the first position for each corrected image and select one of the corrected images that has a maximum contrast difference as a selected image. The “subarea including the first position” refers to a subarea of a corrected image that includes a position (first-position-equivalent position) in the corrected image corresponding to the first position. The size of the subarea is not limited in any particular manner. Contrast difference in a subarea can be calculated by subtracting a minimum pixel value in the subarea from a maximum pixel value in the subarea.

As another example, if the corrected images obtained in substep (a) are saturation-corrected images, for example, the image selecting section 103 may in substep (b) calculate a saturation difference in a subarea including the first position for each corrected image and select one of the corrected images that has a maximum saturation difference as a selected image. Saturation difference in a subarea can be calculated, for example, by converting each pixel value in the subarea to an HSV value and subtracting a minimum saturation S value from a maximum saturation S value in the subarea.

As a further example, if the corrected images obtained in substep (a) are gamma-corrected images, for example, the image selecting section 103 may in substep (b) calculate a contrast difference in a subarea including the first position for each corrected image and select one of the corrected images and the original image that has a maximum contrast difference as a selected image.

In another embodiment, the image selecting section 103 may in step S0103 (image selecting step) select, in accordance with the first position received in step S0102, one of the captured images having been subjected to image correction as a selected image. For example, the image selecting section 103 may in step S0103 calculate a contrast difference in a subarea including the first position for each contrast-corrected captured image and select one of these captured images that has a maximum contrast difference as a selected image. Selecting one of the contrast-corrected captured images as a selected image advantageously improves visibility for the user. Examples of the image correction to which the captured images are subjected include, in addition to contrast correction, gamma correction and saturation correction.

This configuration enables an input of the second position to be received on a corrected image in subsequent step S0104 (second position receiving step), which in turn enables the user to mote accurately designate the second position.

The image selecting section 103 uses publicly known image processing technology to correct the selected image under different correction conditions to generate a plurality of corrected images. The image selecting section 103 selects one of these corrected images in accordance with the first position as a selected image.

The image selecting section 103, for example, calculates a contrast difference in a subarea including the first position for each corrected image and selects one of the corrected images that has a maximum contrast difference as a selected image. Contrast difference in a subarea can be calculated by subtracting a minimum pixel value in the subarea from a maximum pixel value in the subarea.

### ii) Variation Example of Step S0104 (Second Position Receiving Step)

Step S0104 may further include the following substep:

(a) a step in which the second position receiving section 104 further receives an input of a third position in the selected image, the third position differing from the second position (substep S01041).

The second position receiving, section 104 may further receive a designation of a third position in the selected image 210a′ via the input device 12, the third position differing from the second position.

For example, in response to the user designating, via the input device 12, a point 213 (third position) in a partial image of the selected image 210a′ displayed as the scaled-up display image 111 on the display device 11, the point 213 differing from the point 211a′ (second position) (see (b) of FIG. 4), the input device 12 outputs input information on the point 213 to the control section 10 so that the second position receiving section 104 can receive an input of the point 213 (third position) in the selected image 210a′.

The captured image 210a as the selected image 210a′ (see (b) of FIG. 3) is free from grayscale saturation in a region including the corresponding point 211a. The user can visually recognize a point that the user wants to designate in the captured image 210a. Therefore, there occurs no grayscale. saturation around the point 213 (third position) that is present in the same partial image as the point 211a′ (second position). The user can visually recognize the point 213 (third position). Additionally, the second position receiving section 104 causes the display device 11 to display the selected image 210a′ at an enlarged soak, so that the user can easily check and designate the position of a point that the user wants to designate. Any number of positions (e.g., a fourth position and a fifth position) may, similarly to the third position, be designated as positions that differ from the point 211a′ (second position). Detailed description related to these additional positions is omitted.

As described earlier, if a plurality of images is captured of the same subject with different exposure settings in order to generate a synthesized image with a wide dynamic range, discrepancy occurs between the captured images because the images are captured at different times and the image capturing device or the subject may move during the image capturing period. The synthesized image generated from these captured images showing discrepancy can therefore be double vision, which results in a failure to accurately designate the position of a measurement point. In view of this problem, the position designation device 1 uses a synthesized image in such a manner that the user can explore the synthesized image for a desired position of a measurement point and designate a measurement point (second position) in an image selected in accordance with the position (first position) found by the user in the synthesized image. The position designation device 1 therefore does not need to acquire a high-quality synthesized image generated by considering the positional deviations of the subject. The position designation device 1 is also free from the problem that the position of a measurement point cannot be accurately designated in a double-vision synthesized image. In addition, since a position (e.g., third or fourth position) that differs from the second position is designated in a single selected image as shown in (b) of FIG. 4, there is no need to consider the positional deviations of the subject between captured images. It is therefore possible, for example, to measure a distance between the second position and any position that differs from the second position and to measure the area of a region surrounded by the second position and a plurality of any positions that differ from the second position.

### 2. Embodiment 2

The following will specifically describe a position designation device 1 in accordance with a second embodiment of the present invention in reference to drawing.

Throughout the following description about the position designation device 1 in accordance with the second embodiment of the present invention, the “plurality of captured images of the same subject” is a plurality of images of the same subject captured with different focal point location settings, and the “synthesized image generated from captured images” is a synthesized image with an extended depth of field acquired through synthesis from a plurality of images of the same subject captured with different focal point location settings, as an example.

### (1) General Description of Position Designation Device 1

See the description under the heading, “1. Embodiment 1,” for a general description of the position designation device 1 in accordance with the present embodiment. Differences exist only in that the position designation device 1 acquires a “plurality of captured images” of the same subject captured with different focal point location settings and that the “synthesized image” is an image with au extended depth of field synthesized from these captured images.

### (2) Example of Position Designation Process

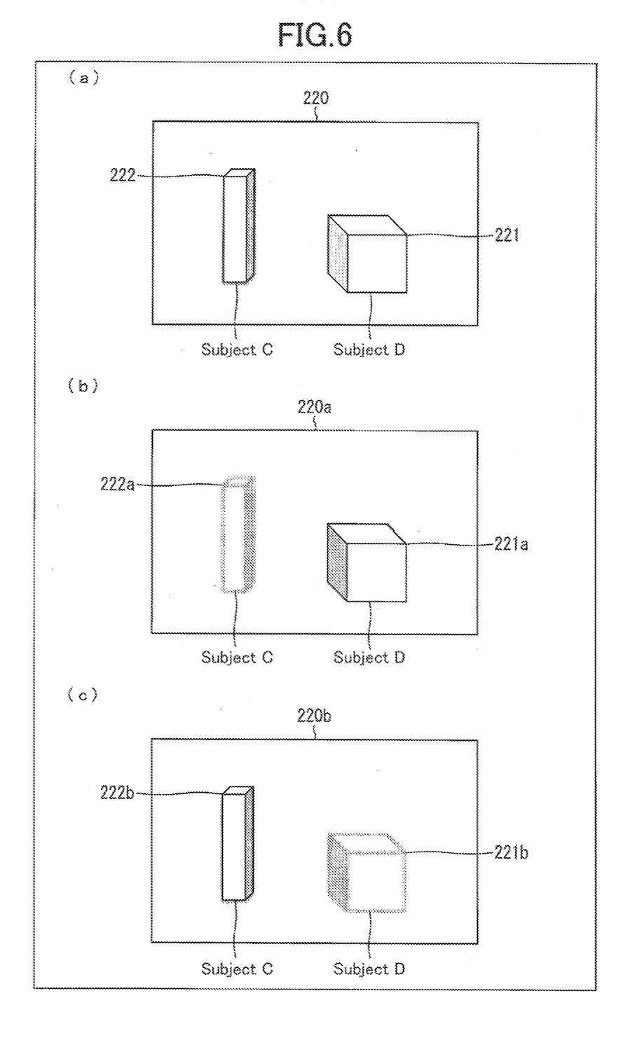

The following will describe an example position designation process performed by the position designation device 1 in reference to FIGS. 2 and 6. FIG. 2 is a flow chart representing a process performed by the position designation device 1 in accordance with the present embodiment. FIG. 6 is an illustration showing example output images generated by the position designation device 1 in accordance with the present embodiment.

### Step S0101: Image Acquisition Step

The image acquisition section 101 in the position designation device 1 in accordance with the present embodiment acquires a plurality of images of the same subject captured with different focal point location settings and a synthesized image generated from these captured images with an extended depth of field.

### Step S0102: First Position Receiving Step

Next, the first position receiving section 102 causes the display device 11 to display the synthesized image and receives a designation of a position (first position) in the synthesized image from the user (operator) via the input device 12.

A synthesized image 220 has an increased depth of field as shown in (a) of FIG. 6. The synthesized image 220 contains a subject C including a point 222 and a subject D including a point 221. Both the subject C and the subject D are in focus. The subject C is located farther from the image capturing position than is the subject D.

Meanwhile, (b) and (c) of FIG. 6 show images 220a and 220b captured with different focal lengths. In other words, the captured images 220a and 220b in (b) and (c) of FIG. 6 represent a plurality of captured images used to generate the synthesized image 220 shown in (a) of FIG. 6. The captured image 220a in (b) of FIG. 6 is an image captured with such a focal point location setting that the focal point lies closer to the image capturing position than is the case with the captured image 220b shown in (c) of FIG. 6.

In the captured image 220a in (b) of FIG. 6, the area showing the subject D including a point 221a is in focus, and the subject C including the area showing a point 222a is out of focus and blurry. If the first position receiving section 102 causes the display device 11 to display the captured image 220a, the user can accurately recognize the position of the point 221a. On the other hand, the user cannot accurately recognize the position of the point 222a, which is out of focus, and will have difficulty in appropriately designating the position of the point 222a.

Meanwhile, in the captured image 220b shown in (c) of FIG. 6, the area showing the subject C including a point 222b is in focus, and the subject D including the area showing a point 221b is out of focus and blurry. If the first position receiving section 102 causes the display device 11 to display the captured image 220b, the user can accurately recognize the position of the point 222b. On the other hand, the user cannot accurately recognize the position of the point 221b, which is out of focus, and will have difficulty in appropriately designating the position of the point 221b.

For these reasons, by causing the display device 11 to display the synthesized image 220 as in (a) of FIG. 6, the first position receiving section 102 enables the user to easily find a desired position (first position) in the synthesized image 220 being displayed on the display device 11. The first position receiving section 102, by so doing, also makes it easier for the user to visually recognize the entire image even when the image includes subjects that are distanced apart. The first position receiving section 102 further enables the user to designate both the point 211 residing in a region relatively close to the image capturing position and the point 212 residing in a region relatively far from the image capturing position in the same synthesized image 220, which can prevent a failure to designate a desired point due to the blurriness of the subject.

The first position receiving section 102 may receive an input of a desired position for a point in the synthesized image 220 and may receive an input of a desired position for a region in the synthesized image 220.

### Step S0103

Next, the image selecting section 103 selects, as a selected image, one of the captured images in accordance with the first position received in step S0102.

The image selecting section 103 may select an image, for example, by calculating a focusing level of a subarea including the first position for each captured image and selecting one of the captured images that has a maximum focusing level as the selected image. The “subarea including the first position” refers to a subarea of a captured image that includes a position (first-position-equivalent position) in the captured image corresponding to the first position. The size of the subarea is not limited in any particular manner and may be, for example, a rectangular region containing a predetermined number of pixels. The selected image prepared in this manner includes an increased number of well-focused subjects in the subarea including the first position.

More specifically, as the first position receiving section 102 receives an input of the point 221 in the synthesized image 220 as the first position (see (a) of FIG. 4, the image selecting section 103 calculates a focusing level of a subarea of each captured image, the subarea including a point (corresponding point) that corresponds to the point 221 in that captured image. As an example, the image selecting section 103 calculates a focusing level of a subarea of the captured image 220a, the subarea including the corresponding point 221a in the captured image 220a (see (b) of FIG. 6), and similarly calculates a focusing level of a subarea of the captured image 220b, the subarea including the corresponding point 221b in the captured image 220b (see (c) of FIG, 6). The image selecting section 103 then selects one of the captured images that has a maximum focusing level as a selected image. The image selecting section 103, in the present embodiment, selects the captured image 220a as a selected image (see (b) of FIG. 6). The image selecting section 103 may store the selected image in a storage device.

The image selecting section 103, in an aspect, evaluates the “focusing level” by means of contrast difference in a predetermined region around each pixel. The image selecting section 103 determines that the focusing level is higher if the region has a greater contrast difference. Accordingly, the “one of the captured images that has a maximum focusing level” is one of the captured images that has a subarea having a maximum contrast difference.

### Step S01041 Second Position Receiving Step

Next, the second position receiving section 104 causes the display device 11 to display at least a pan of the captured image 220a as a selected image and receives a designation of a position (second position) in the selected image from the user via the input device 12.

The display device 11 displays the selected image as described earlier under the heading, “1. Embodiment 1.”

The position designation device 1 can improve visibility for the user searching an image for a position that the user wants to designate, by displaying the entire synthesized image that has an extended depth of field. Furthermore the position designation device 1 can select a captured image that has a maximum focusing level as a selected image in accordance with the position (first position) designated by the user in the synthesized image, so that the user can designate a position (second position) in the selected image. Therefore, the user can accurately designate a position that the user wants to designate in an image. If a plurality of images is captured with different focal point settings, there may occur positional deviations of the subject between the captured images because the angle of view could change with changing focal point location. The synthesized image with an extended depth of field generated from images captured with different focal point location settings can therefore be double vision even when the position designation device 1 is not shaken and the subject stays still while imaging.

The position designation device 1 uses a synthesized image in such a manner that the user can explore the synthesized image for a desired position of a measurement point and designate a measurement point in an image selected in accordance with the position (first position) found by the user in the synthesized image. The position designation device 1 therefore does not need to acquire a high-quality synthesized image generated by considering the positional deviations of the subject. Even when the synthesized image is double vision, since the measurement point is designated in the selected image, the position designation device 1 is free from the problem that the position of a measurement point cannot be accurately designated in a double-vision synthesized image.

### (3) Variation Example of Position Designation Device 1

The variation examples of the position designation device 1 described earlier under the heading, “1. Embodiment 1,” are also applicable to the position designation device 1 in accordance with the present embodiment.

Throughout the present embodiment, the “plurality of captured images of the same subject” is, as an example, a plurality of images of the same subject captured with different focal point location settings, and the “synthesized image generated from captured images” is, as an example, a synthesized image obtained by combining the plurality of images of the same subject captured with different focal point location settings in such a manner as to extend the depth of field of the resultant synthesized image. These examples may be combined with the exposure settings described earlier under the heading, “1. Embodiment 1.” Specifically, the “plurality of captured images of the same subject” may be a plurality of images of the same subject captured with different focal point location settings and different exposure level settings, and the “synthesized image generated from captured images” may be a synthesized image obtained by combining the plurality of images of the same subject captured with different focal point location settings and different exposure level settings in such a manner as to extend the dynamic range and depth of field of the resultant synthesized image.

When these images are used, an image may be selected as a selected image, for example, by calculating the grayscale saturation level and the focusing level of a subarea including the first position for each captured image and selecting one of the captured images that has a minimum grayscale saturation level and a maximum focusing level. The “subarea including the first position” refers to a subarea of a captured image that includes a position (first-position-equivalent position) in the captured image corresponding to the first position. The size of the subarea is not limited in any particular manner.

### 3. Embodiment 3

The following will specifically describe a measuring instrument 100 (position designation device) in accordance with a third embodiment of the present invention in reference to drawings.

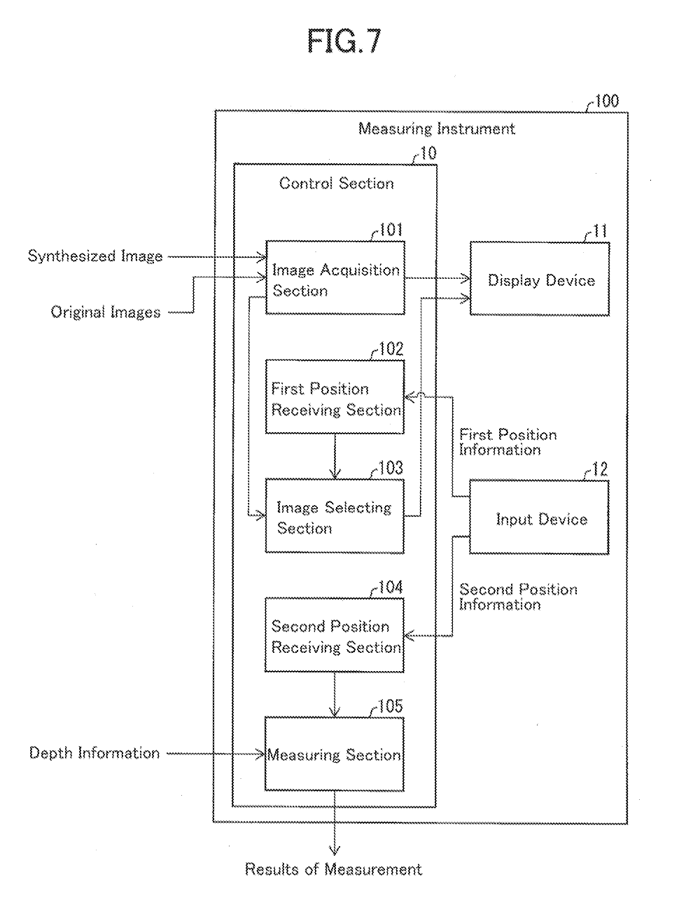

FIG. 7 is a block diagram of an example configuration of the measuring instrument 100 in accordance with the third embodiment of the present invention.

Referring to FIG. 7, the measuring instrument 100 includes a control section 10, a display device 11, and an input device 12. The control section 10, the display device 11, and the input device 12 may be integrated into a single apparatus or provided separately.

The control section 10 controls the overall operation of the measuring instrument 100 and serves as an image acquisition section 101, a first position receiving section 102, an image selecting section 103, a second position receiving section 104, and a measuring section 105. The processes implemented by the control section 10 will be described later in detail.

### (1) General Description of Measuring Instrument 100

The measuring instrument 100 acquires a plurality of captured images of the same subject (which hereinafter may be referred to simply as “captured images”) and a synthesized image generated from these captured images (which hereinafter may be referred to simply as a “synthesized image”). The measuring instrument 100 then causes the display device 11 to display the synthesized image and receives a designation of a position (first position) in the synthesized image from the user (operator) via the input device 12. Next, the measuring instrument 100 selects as a selected image one of the captured images in accordance with the received first position. Subsequently, the measuring instrument 100 causes the display device 11 to display at least a part of the selected image and receives a designation of a position (second position) in the selected image from the user via the input device 12. The measuring instrument 100 then acquires depth information associated with the selected image and calculates the three-dimensional position (coordinates) of a position on the subject, the latter position corresponding to the second position in the selected image. This configuration enables the user to measure the three-dimensional position (coordinates) of a desired measurement point in the captured image.

Since the control section 10 of the measuring instrument 100 serves as the image acquisition section 101, the first position receiving section 102, the image selecting section 103, and the second position receiving section 104 as described earlier under the headings, “1. Embodiment 1” and “2. Embodiment 2,” the user can accurately and easily designate a desired measurement point in an image. By referring to the depth information associated with the selected image on the basis of the position information (second position information) acquired in this manner in the selected image, the measuring instrument 100 can accurately and in an error-reduced manner measure the three-dimensional position (coordinates) of a position (measurement point) on the subject, the latter position corresponding to the second position in the selected image.

### (2) Example of Measuring Process

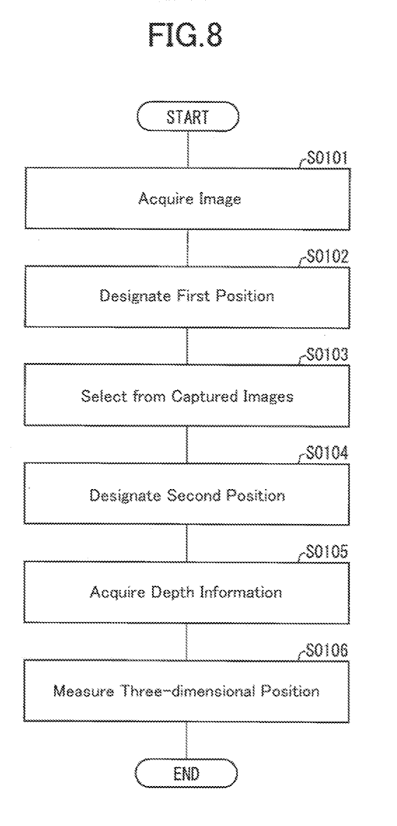

The following will describe an example measuring process performed by the measuring instrument 100 in reference to FIG. 8. FIG. 8 is a flow chart representing a process performed by the measuring instrument 100 in accordance with the present embodiment.

### Steps S0101 to S0104

Steps S0101 to S0104 have been described earlier under the headings, “1. Embodiment 1” and “2. Embodiment 2.” Description thereof is not repeated here.

### Step S0105: Depth Information Acquisition Step

The measuring section 105 receives depth information. The depth information received by the measuring section 105 is associated with the selected image (in other words, the captured image used in the designation of the second position).

### Step S0106: Three-Dimensional Position Measuring Step

The measuring section 105 calculates the three-dimensional position (coordinates) of a position (measurement point) on the subject, the latter position corresponding to the second position in the selected image, in reference to the second position information and the depth information. The measuring section 105 outputs results of the measurement for storage in a storage device (not shown) and/or for a display on the display device 11.

Depth information may be acquired, for example, by using a pair of stereoscopic images, by calculating reflection time of ultrasound to calculate distance, by an infrared-light-based TOF (time of flight) method, or by emitting patterned light to calculate distance. Depth information may be combined with a camera parameter such as the focal length of an image, in order to calculate three-dimensional information for a space surrounding the measurement point.

The measuring instrument 100 allows the user to designate the first position in a synthesized image, thereby improving visibility for the user to find the first position. In addition, the measuring instrument 100 can select one of captured images as a selected image in accordance with the position (first position) designated by the user in the synthesized image, so that the user can designate a position (second position in the selected image. Therefore, the user can accurately designate a position that the user wants to designate in an image. As a result, the measuring instrument 100 is capable of acquiring more accurate three-dimensional information on a desired position.

### (3) Variation Example of Measuring Instrument 100

The variation examples of the position designation device 1 described earlier under the headings, “1. Embodiment 1” and “2. Embodiment 2,” are also applicable to the measuring instrument 100.

### 4. Embodiment 4

The following will specifically describe a measuring instrument 100 (position designation device) in accordance with a fourth embodiment of the present invention in reference to drawings.

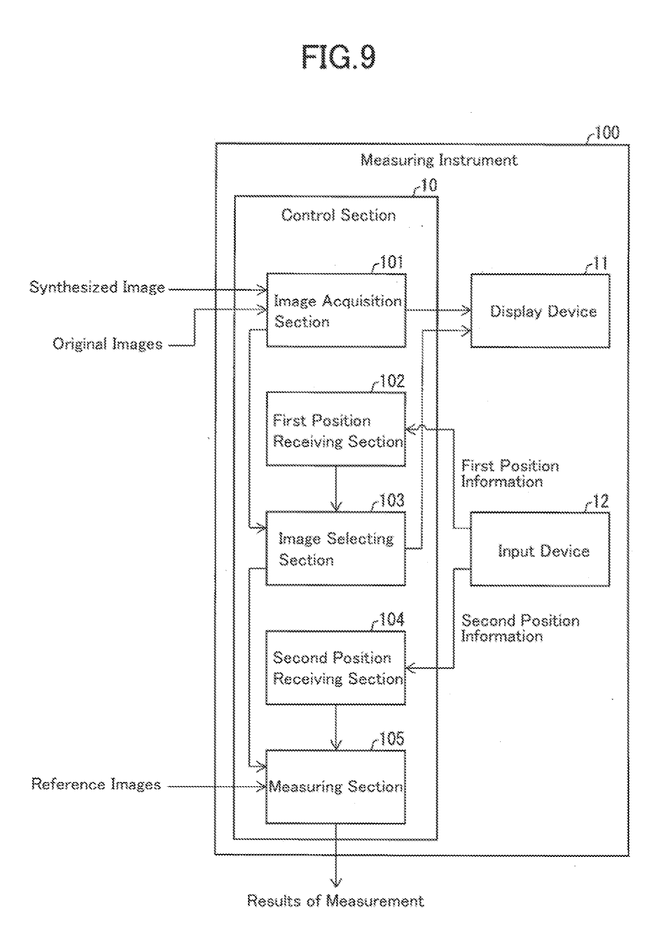

FIG. 9 is a block diagram of an example configuration of the measuring instrument 100 in accordance with the fourth embodiment of the present invention. Referring to FIG. 9, the measuring instrument 100 includes a control section 10, a display device 11 and an input device 12. The control section 10, the display device 11, and the input device 12 may be integrated into a single apparatus or provided separately.

The control section 10 controls the overall operation of the measuring instrument 100 and serves as an image acquisition section 101, a first position receiving section 102, an image selecting section 103, a second position receiving section 104, and a measuring section 105. The processes implemented by the control section 10 will be described later in detail.

### (1) General Description of Measuring Instrument 100

The measuring instrument 100 acquires a plurality of captured images of the same subject (which hereinafter may be referred to simply as “captured images”) and a synthesized image generated from these captured images (which hereinafter may be referred to simply as a “synthesized image”). The measuring instrument 100 then causes the display device 11 to display the synthesized image and receives a designation of a position (first position) in the synthesized image from the user (operator) via the input device 12. Next, the measuring instrument 100 selects as a selected image one of the captured images in accordance with the received first position. Subsequently, the measuring instrument 100 causes the display device 11 to display at least a part of the selected image and receives a designation of a position (second position) in the selected image from the user via the input device 12. The measuring instrument 100 then further acquires a reference image associated with the selected image and calculates, in reference to the reference image, the three-dimensional position (coordinates) of a position on the subject, the latter position corresponding to the second position in the selected image.

Since the control section 10 of the measuring instrument 100 serves as the image acquisition section 101, the first position receiving section 102, the image selecting section 103, and the second position receiving section 104 as described earlier under the headings, “1. Embodiment 1” and “2. Embodiment 2,” the user can accurately and easily designate a desired measurement point in an image. By referring to a reference image associated with the selected image on the basis of the position information (second position information) acquired in this manner in the selected image, the measuring instrument 100 can accurately and in an error-reduced manner calculate the three-dimensional position (coordinates) of a position (measurement point) on the subject, the latter position corresponding to the second position in the selected image.

### (2) Example of Measuring Process

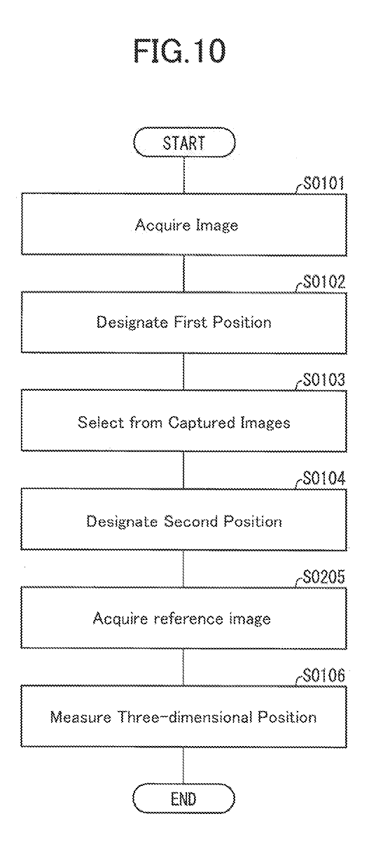

The following will describe an example measuring process performed by the measuring instrument 100 in reference to FIG. 10. FIG. 10 is a flow chart representing a process performed by the measuring instrument 100 in accordance with the present embodiment.

### Steps S0101 to S0104

Steps S0101 to S0104 have been described earlier under the headings, “1. Embodiment 1” and “2. Embodiment 2.” Description thereof is not repeated here.

### Step S0205: Reference image Acquisition Step

The measuring section 105 acquires a reference image associated with the selected image. A reference image is an image captured of the same subject as is the selected image, but from a different image capturing position and provides a pair of stereoscopic images when combined with the selected image. The measuring section 105 in an aspect, may acquire in advance reference images each associated with a different one of the captured images and select one of the reference images that is associated with the selected image in order to acquire a reference image that is associated with the selected image.

### Step S0106: Three-Dimensional Position Measuring Step

The measuring section 105 calculates depth information associated with the second position in reference to the reference image associated with the selected image and calculates the three-dimensional position (coordinates) of a position (measurement point) on the subject, the latter position corresponding to the second position in the selected image, in reference to the second position information and the depth information. The measuring, section 105 outputs results of the measurement for storage in a storage device (not shown) and/or for a display on the display device 11.

Depth information may be calculated, for example, by triangulation or block matching.

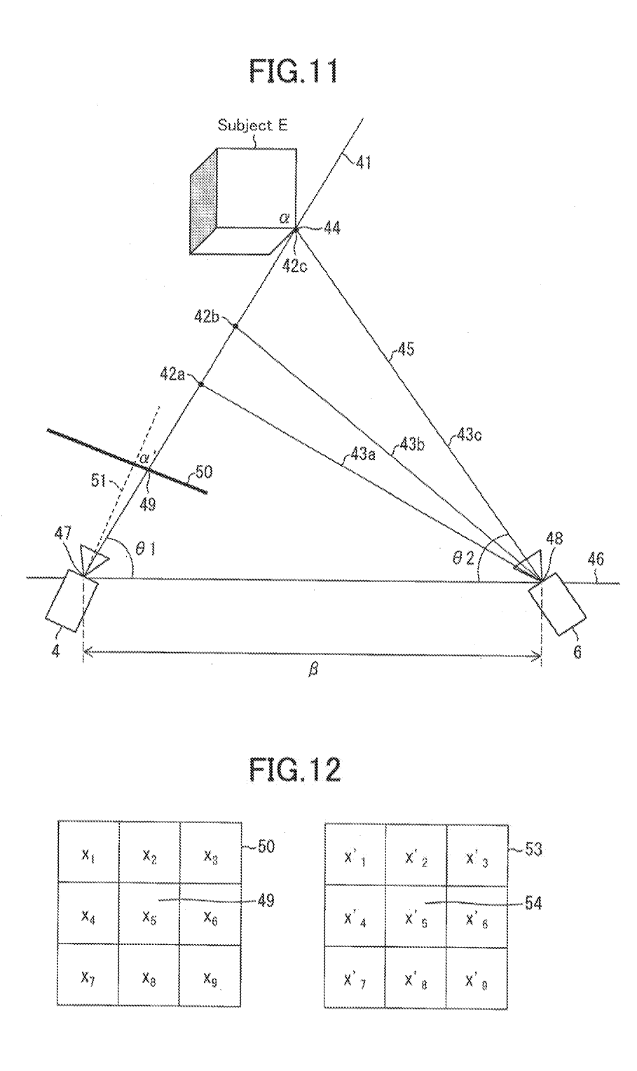

A description will now be given of a triangulation-based method as an example method of calculating depth information using a pair of stereoscopic images consisting of a selected image and a reference image associated with the selected image in reference to FIG. 11. FIG. 11 is an illustration of a triangulation-based method.

Referring to FIG. 11, there are provided a base image capturing section 4 and a reference image capturing section 6 arranged so as to have a common image capturing range. The base image capturing section 4 and the reference image capturing section 6 are fixed in position relative to each other. The relative positions of the base image capturing section 4 and the reference image capturing section 6 are measured in advance. A measurement point α on a subject E has three-dimensional coordinates 44 on a straight line 41 passing through image coordinates 49 of a corresponding measuring point α′ in a captured image 50 taken by the base image capturing section 4 and also through a focal point 47 of the base image capturing section 4 and through the image coordinates 49 of the corresponding measuring point α′.

A plurality of search points 42 (e.g., search points 42a, 42b, and 42c) is then specified on the straight line 41. Search straight lines 43 (e.g., search straight lines 43a, 43b, and 43c) are also specified each passing through a focal point 48 of the reference image capturing section 6 and a different one of the search points 42. Each corresponding search point in a captured image (not shown) taken by the reference image capturing section 6 is compared with the corresponding measuring point α′ in the captured image 50 taken by the base image capturing section 4, to detect one of the corresponding search points where the same object is captured in the image. The search point on the straight line 41 that corresponds to this corresponding search point (in this case, the search point 42c) is the three-dimensional coordinates 44 of the measurement point α on the subject E. The three-dimensional coordinates 44 of the measurement point α on the subject E can be calculated relative to the base image capturing section 4 and the reference image capturing section 6, from the positional relationship of three straight lines: namely, the straight line 41, a base line 46 that is a straight line passing through the focal point 47 of the base image capturing section 4 and the focal point 48 of the reference image capturing section 6, and a straight line 45 passing through the focal point 48 and the three-dimensional coordinates 44 of the measurement point α on the subject E.

Specifically, a distance β along the base line 46 between the focal point 47 and the focal point 48 is measured in advance. An angle θ1 between the straight line 41 and the base line 46 and an angle θ2 between the straight line 45 and the base line 46 are then calculated. The three-dimensional coordinates 44 of the measurement point a on the subject E can be calculated from the distance β, the angle θ1, and the angle θ2 by relying on congruence of triangles.

The angle θ1 and the angle θ2 can be calculated using a camera projection model, which will now be described in detail in reference to FIG. 11.

An image capturing section is composed of an imaging device, lenses, and other components. The image capturing section may be understood to record an image of a subject at coordinates on a projection face at which a straight line linking a thermal point and a subject to be imaged intersects the projection face. Therefore, as shown in FIG. 11, the location of the straight line 41 passing through the focal point 47 and the image coordinates 49 of the corresponding measuring point α′ can be calculated if the three-dimensional spatial position of the focal point 47 of the base image capturing section 4 and the three-dimensional spatial position of the image coordinates 49 of the corresponding measuring point α′ on the projection face oil which the captured image 50 is projected are known. Note that the position of the projection face of the base image capturing section 4 is dictated by the focal point location of the base image capturing section 4 and the orientation of an optical axis 51 of the base image capturing section 4.

Accordingly, a sensor pixel pitch and a positional relationship between a sensor and a focal point are measured in advance in the base image capturing section 4 and the reference image capturing section 6 as shown in FIG. 11. If these parameters are known, the position of the straight line 41 in the real space can be calculated, which corresponds to the image coordinates 49 of the corresponding measuring point α′. The positions of the straight line 41 and the straight line 45 relative to the base image capturing section 4 and the reference image capturing section 6 can be calculated in this manner. If the relative positions of the base image capturing section 4 and the reference image capturing section 6 are measured in advance, the angle θ1 and the angle θ2 can be calculated, and the position of the three-dimensional coordinates 44 of the measurement point a on the subject F can be calculated relative to the base image capturing section 4 and the reference image capturing section 6.

When images are captured of the same subject with different focal point locations, the positional relationship between the focal point 47 and the projection face differs from one focal point location to another. Accordingly, the positional relationship between the focal point 47 and the projection face is measured in advance for each focal point location in image capturing. Then, the relative position of the straight line 41 can be calculated, which in turn enables calculation of the three-dimensional coordinates 44 of the measurement point a on the subject E.

Next, a description will be given of a block-matching-based method in reference to FIG. 12. The image coordinates 49 of the corresponding measuring point if in the captured image 50 image taken by the base image capturing section 4 is compared with image coordinates 54 (not shown in FIG. 11) of a corresponding search point in a reference image 53 taken by the reference image capturing section 6, as shown in FIG. 12. If the image coordinates 49 and the image coordinates 54 have a high similarity level, it can be safely determined that the images are of the same object, in other words, that the search point 42 (FIG. 11) in the three-dimensional space corresponding to the corresponding search point is the three-dimensional coordinates 44 of the measurement point a on the subject E.

The similarity level can be evaluated by means of an evaluation function such as SAD (sum of absolute difference) or SSD (sum of squared difference). An SAD value is calculated as follows. Letting x₅ represent a pixel corresponding to the image coordinates 49 of the corresponding measuring point α′ and x′₅ represent a pixel corresponding to the image coordinates 54 of the corresponding search point, Equation (1) below is evaluated using the pixel values of the 3×3 pixels surrounding and including x₅ or x₅′ shown in FIG. 12, to obtain an SAD value.

$$\begin{matrix}[ Math . 1 ] & \\ SAD = {\sum }_{i = 1}^{9} \vert {x}_{i} - {x}_{i}^{′} \vert & ( 1 )\end{matrix}$$

If the same object appears at the image coordinates 49 of the corresponding measuring point α′ and at the image coordinates 54 of the corresponding search point, the pixels have close pixel values, which decreases the SAD value. Hence, by selecting one of the search points 42 specified on the straight line 41 (FIG. 11) that has a minimum SAD value, the three-dimensional coordinates 44 of the measurement point a can be calculated.

The pair of images captured by the base image capturing section 4 and the reference image capturing section 6 for use as a comparison target is preferably captured in a synchronized manner because the images will have no discrepancy that is attributable to the shaking of the subject and the position designation device 1. Additionally, this synchronized image capturing is preferably performed with the same exposure settings because the results of the SAD-value-based detection become more reliable. The pair of a base image and a reference image used as a comparison target preferably has a greater contrast difference than the other pairs of a base image and a reference image because such a pair is more likely to produce an SAD value difference and lead to improved precision in the calculation of the three-dimensional coordinates 44 of the measurement point α. For example, since an image containing many saturated regions contains many similar regions, errors in the detection can be made less likely to occur by using an image containing few saturated regions as a comparison target.

### (3) Variation Example of Measuring Instrument 100

The variation examples of the position designation device 1 described earlier under the headings, “1. Embodiment 1” and “2. Embodiment 2,” are also applicable to the measuring instrument 100.

### (i) Variation Example of Step S0101 (Image Acquisition Step) and Step S0205 (Reference Image Information Acquisition Step)

FIG. 9 shows the measuring section 105 acquiring a plurality of reference images. Alternatively, when the image acquisition section 101 acquires a plurality of captured images and a synthesized image, the image acquisition section 101 may also acquire a plurality of reference images. Specifically, the image acquisition section 101 may acquire a plurality of captured images, a synthesized image, and a plurality of reference images in step S0101 (image acquisition step).

Meanwhile, the measuring section 105 may acquire second position information and a pair of stereoscopic images (i.e., a selected image and a reference image associated with the selected image).

### Variation Example of Step S0104 (Second Position Receiving Step)

Step S0104 may further include the following substep:

(a) a step in which the second position receiving section 104 further receives an input of a third position in the selected image, the third position differing from the second position (substep S01041).

The third position, which differs from the second position, is designated in the selected image as described earlier under the heading, “1. Embodiment 1.”

### (iii) Variation Example of Step S0106 (Three-dimensional Position Measuring Step)

Step S0106 may further include the following substep:

(a) a step in which the measuring section 105, in reference to a reference image associated with the selected image in which depth information has been calculated for the second position, measures the three-dimensional position (coordinates) of the position (measurement point) on the subject, the latter position corresponding to the third position in the selected image (substep S01061).

The third position, which differs from the second position is designated in the same selected image as the selected image in which the second position is designated, and a distance between two points is calculated in the single selected image. This configuration can reduce measurement errors that are attributable to movements of the subject, which in turn enables high precision calculation of a distance between two points. If a fourth position and a fifth position are further designated in the same selected image, and the three-dimensional positions (coordinates) of the positions (measurement points) on the subject, the latter positions corresponding to the fourth position and the fifth position in the selected image, are measured, it becomes possible to calculate an area and other measurement with high precision.

### (iv) Other Examples of Image Acquired by Image Acquisition Section

Depth information is calculated using a pair of stereoscopic images (specifically, a captured image and a reference image) as an example in the present embodiment. Alternatively, a set of images of the same subject captured from three or more different positions (specifically, a combination of a captured image and two or more reference images) may be used in place of a pair of stereoscopic images, which still produces similar effects.

### 5. Embodiment 5

The following will specifically describe a measuring instrument 100 (position designation device) in accordance with a fifth embodiment of the present invention in reference to drawings.

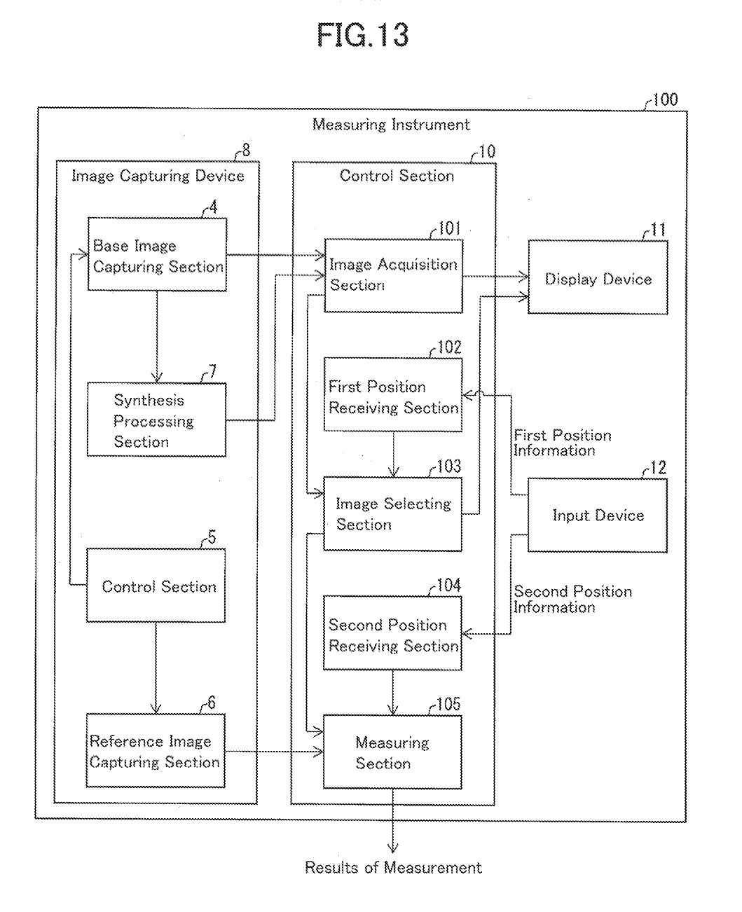

FIG 13 is a block diagram of an example configuration of the measuring instrument 100 in accordance with the fifth embodiment of the present invention. Referring to FIG. 13, the measuring instrument 100 includes a control section 10, a display device 11, an input device 12, and an image capturing device 8. The control section 10, the display device 11, and the input device 12 may be integrated into a single apparatus or provided separately.

The control section 10 controls the overall operation of the measuring instrument 100 and serves as an image acquisition section 101, a first position receiving section 102, an image selecting section 103, a second position receiving section 104, and a measuring section 105. The processes implemented by the control section 10 will he described later in detail.

The image capturing device 8 includes a base image capturing section 4 (image capturing section), a control section 5, a reference image capturing section 6 (image capturing section), and a synthesis processing section 7 (synthesizing section). The base image capturing section 4 and the reference image capturing section 6 may be built around lenses and imaging devices such as CCDs (charge coupled devices).

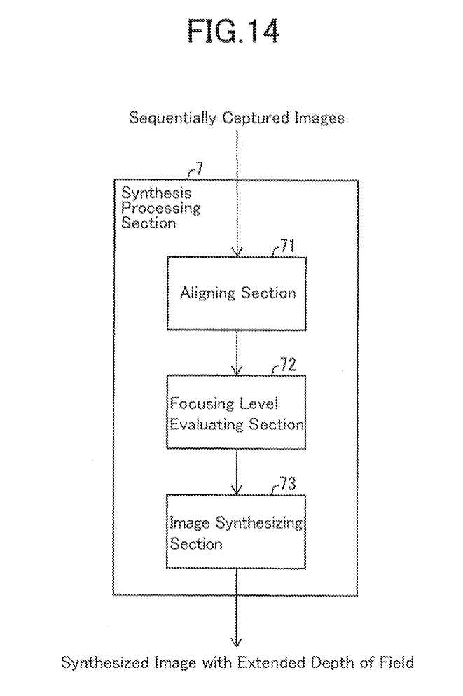

FIG. 14 is a block diagram of an example configuration of the synthesis processing section 7 of the image capturing device 8 in the measuring instrument 100 in accordance with the fifth embodiment of the present invention. The synthesis processing, section 7 includes an aligning section 71, a focusing level evaluating section 72, and an image synthesizing section 73.

### (1) General Description of Measuring Instrument 100

The image capturing device 8 in the measuring instrument 100 captures a plurality of images of the same subject under a plurality of predetermined image capturing conditions (e.g., exposure level and focal point location). Next, the image capturing device 8 acquires a plurality of captured images of the same subject and generates a synthesized image from these captured images. The measuring instrument 100 then acquires the captured images of the same subject and the synthesized image. Subsequently, the measuring instrument 100 causes the display device 11 to display the synthesized image and receives a designation of a position (first position) in the synthesized image from the user (operator) via the input device 12. Next, the measuring instrument 100 selects as a selected image one of the captured images in accordance with the received first position. Subsequently, the measuring instrument 100 causes the display device 11 to display at least a part of the selected image and receives a designation of a position (second position) in the selected image from the user via the input device 12. The measuring instrument 100 then further acquires reference images associated respectively with the captured images and calculates, in reference to one of the reference images associated with the selected image, the three-dimensional position (coordinates) of a position on the subject, the latter position corresponding to the second position in the selected image.

Since the control section 10 of the measuring instrument 100 serves as the image acquisition section 101, the first position receiving section 102, the image selecting section 103, and the second position receiving section 104 as described earlier under the headings, “1. Embodiment 1” and “2. Embodiment 2,” the user can accurately and easily designate a desired measurement point in an image. By referring to a reference image associated with the selected image on the basis of the position information (second position information) acquired in this manner in the selected image, the measuring instrument 100 can accurately and in an error-reduced manner calculate the three-dimensional position (coordinates) of a position (measurement point) on the subject, the latter position corresponding to the second position in the selected image.

### (2) Example of Measuring Process

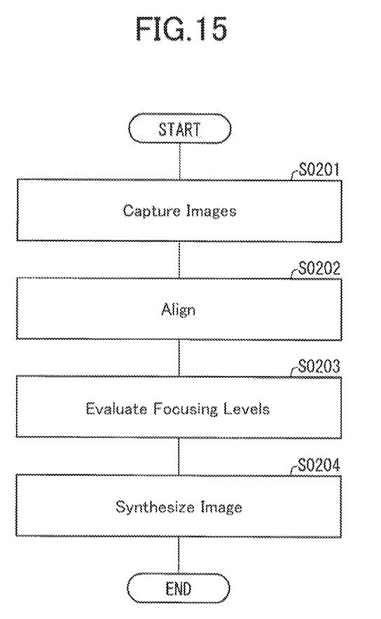

The following will describe an example measuring process performed by the measuring instrument 100 in reference to FIGS. 10, 14 and 15. FIG. 10 is a flow chart representing a process performed by the measuring instrument 100 in accordance with the present embodiment. FIG. 14 is a block diagram of an example configuration of the synthesis processing section 7 of the measuring instrument 100 in accordance with the present embodiment. FIG. 15 is a flow chart representing a process performed by the synthesis processing section 7.

Prior to step S0101 shown in FIG. 10, the measuring instrument 100 implements steps S0201 to S0204 in which: the base image capturing section 4 and the reference image capturing section 6 of the image capturing device 8 capture a plurality of images of the same subject under a plurality of predetermined image capturing conditions (e.g., exposure level and focal point location); and the synthesis processing section 7 combines the images captured by the base image capturing section 4 to acquire a synthesized image. A description will be first given of steps S0201 to S0204 in reference to FIG. 15.

### Step S0201: Imaging Step

The base image capturing section 4 and the reference image capturing section 6 capture a plurality of images of the same subject under a plurality of predetermined image capturing conditions (e.g., exposure level and focal point location). In the present embodiment, the base image capturing section 4 and the reference image capturing section 6 capture images with different focal point location settings.

The control section 5 controls shutter timings for the base image capturing section 4 and the reference image capturing section 6 and also controls the diaphragm, sensor sensitivity, shutter speed, focal point location, and other image capturing settings of the base image capturing section 4 and the reference image capturing section 6. The control section 5, upon receiving an input signal from, for example, a shutter button (not shown), controls the base image capturing section 4 and the reference image capturing section 6 to capture a plurality of images under a plurality of predetermined image capturing conditions (e.g., exposure level and focal point location).

The control section 5 controls the base image capturing section 4 and the reference image capturing section 6 to close their shutters approximately simultaneously in order to capture each pair of images in a synchronized manner. If the predetermined image capturing conditions include different focal point locations, a common focal point location setting is used in both the base image capturing section 4 and the reference image capturing section 6, and the setting is varied for each pair of synchronized images, such that the base image capturing section 4 and the reference image capturing section 6 are separated from the subject to be focused on by substantially the same distance, in other words, such that the base image capturing section 4 and the reference image capturing section 6 can focus on the same subject. The reference image capturing section 6 is located to the right of the base image capturing section 4 in the present embodiment. Alternatively, the reference image capturing section 6 may be located to the left of the base image capturing section 4 and may be located above or below the base image capturing section 4. In addition, the present embodiment provides a single reference image capturing section 6, that is, a total of two image capturing sections. Alternatively, the present embodiment may provide two or more reference image capturing sections.

The base image capturing section 4 and the reference image capturing section 6 output captured images to the image acquisition section 101. The base image capturing section 4 also outputs captured images to the synthesis processing section 7. Image data is described in the present embodiment as being sequentially outputted to the synthesis processing section 7 and the image acquisition section 101. Alternatively, the captured images may be temporarily stored in a memory section (not shown) in the measuring instrument 100 so that the synthesis processing section 7 and the image acquisition section 101 can acquire the data from the memory section (not shown).

### Step S0202: Aligning Step

If the base image capturing section 4 has captured images al the same subject with different focal point location settings, the synthesis processing section 7 aligns the captured images that have different focal point locations, evaluates the focusing level of each pixel, and weighted-averages the pixel values of image pixels that have high focusing levels to generate a synthesized image with an extended depth of field.

The aligning section 71 aligns the captured images that have been acquired from the base image capturing section 4 and that have different focal point locations. As mentioned above, since the angle of view may differ from one image to another, the aligning section 71 compares the coordinates of a feature point in a pair of images and adjusts the coordinates so that the feature point has the same coordinates in the pair of images. This configuration can place the subject at substantially the same position in the pair of images.

### Step S0203: Focusing Level Evaluating Step

Subsequently, the focusing level evaluating section 72 evaluates the focusing level of each pixel in each image by means of contrast difference in a predetermined region around each pixel. The focusing level evaluating section 72 determines that the focusing level is higher if the region has a greater contrast difference.

### Step S0204: Image Synthesis Step

Next, the image synthesizing section 73 synthesizes an image on the basis of the evaluation of the focusing levels. Images can be synthesized by a common synthesis method. The pixel value of each pixel in the synthesized image can be calculated using Equation (2) below, where N represents the number of captured images, pi represents the pixel value of a pixel under consideration in a captured image i, ci represents the focusing level of the pixel under consideration and paf represents the pixel value of a pixel under consideration in the synthesized image.

$$[ Math . 2 ]$$

$${p}_{af} = {\sum }_{i}^{N} \frac{{p}_{i} {c}_{i}}{{\sum }_{i}^{N} {c}_{k}} \qquad ( 2 )$$

An image can be synthesized with an extended depth of field by focusing-level-weighted averaging the pixel values in the captured images to calculate the pixel value of each pixel. The resultant synthesized image is outputted to the image acquisition section 101 from the synthesis processing section 7 (image synthesizing section 73).

### Steps S0101 to S0104

Steps S0101 to S0104 have been described earlier under the heading, “2. Embodiment 2.” Description thereof is not repeated here.

### Steps S0205 and S0106

Steps S0205 and S0106 have been described earlier under the heading, “4. Embodiment 4.” Description thereof is not repeated here.

### (3) Variation Example of Measuring Instrument 100

The variation examples of the position designation device 1 described earlier under the headings, “1. Embodiment 1” and “2. Embodiment 2,” are also applicable to the measuring instrument 100. The variation examples of the measuring instrument 100 described earlier under the headings, “3. Embodiment 3” and “4. Embodiment 4,” are also applicable to the measuring instrument 100 in accordance with the present embodiment.

### (1) Examples under Other Image Capturing Conditions

The base image capturing section 4 and the reference image capturing section 6 have been described in the present embodiment as capturing images with different focal point location settings. Alternatively, the base image capturing section 4 and the reference image capturing section 6 may capture images with different exposure level settings.

In this alternative example, a common exposure level setting is used in step S0201 in both the base image capturing section 4 and the reference image capturing section 6, and the setting is varied for each pair of synchronized images.

In addition, in step S0204, the image synthesizing section 73 aligns the captured images that have different exposure levels, weighted-averages image pixels that have suitable gray levels in each pixel, and adjusts the gray level by considering an exposure level differences across the image, in order to generate a synthesized image with an extended dynamic range. If the synthesized image has an excessive bit count, the synthesized image may be subjected to, for example tone mapping for gray level conversion to a desired bit count.

### 6. Embodiment 6

The measuring instrument 100 not only calculates a distance from the measuring instrument 100 (specifically, the focal point of the base image capturing section 4) to the three-dimensional position of the measurement point, but is also capable of, as an example, calculating a distance between two points. The following will describe how this additional function is implemented.

The following will specifically describe a measuring instrument 100 (position designation device) in accordance with a sixth embodiment of the present invention in reference to drawings.

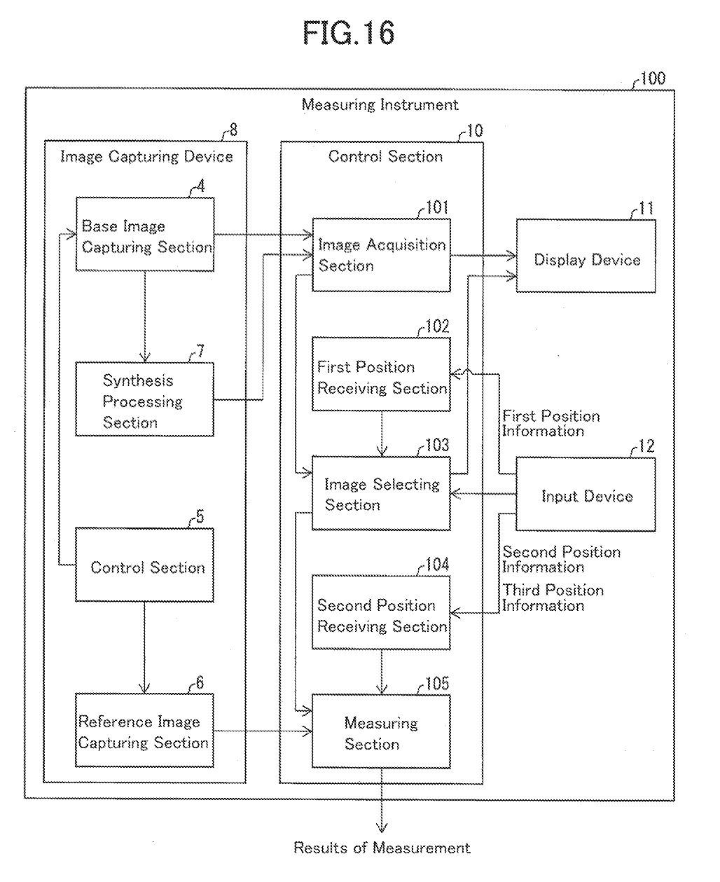

FIG. 16 is a block diagram of an example configuration of the measuring instrument 100 in accordance with the sixth embodiment of the present invention. Referring to FIG. 16, the measuring instrument 100 includes a control section 10, a display device 11, an input device 12, and an image capturing device 8. The control section 10, the display device 11, and the input device 12 may be integrated into a single apparatus or provided separately.

The control section 10 controls the overall operation of the measuring instrument 100 and serves as an image acquisition section 101, a first position receiving section 102, an image selecting section 103, a second position receiving section 104, and a measuring section 105. The processes implemented by the control section 10 will be described later in detail.

The image capturing device 8 includes a base image capturing section 4 (image capturing section), a control section 5, a reference image capturing section 6 (image capturing section), and a synthesis processing section 7 (synthesizing section).

### (1) General Description of Measuring Instrument 100

The image capturing device 8 in the measuring instrument 100 captures a plurality of images of the same subject under a plurality of predetermined image capturing conditions (e.g., exposure level and focal point location). Next, the image capturing device 8 acquires a plurality of captured images of the same subject and generates a synthesized image from these captured images. The measuring instrument 100 then acquires the captured images of the same subject and the synthesized image. Subsequently, the measuring instrument 100 causes the display device 11 to display the synthesized image and receives a designation of a position (first position) in the synthesized image from the user (operator) via the input device 12. Next, the measuring instrument 100 selects as a selected image one of the captured images in accordance with the received first position. Subsequently, the measuring instrument 100 causes the display device 11 to display at least apart of the selected image and receives a designation of a position (second position) in the selected image from the user via the input device 12. The measuring instrument 100 then receives a designation of a third position in the selected image from the user via the input device 12, the third position differing from the second position, and re-selects the selected image in accordance with the third position. Next, the measuring instrument 100 causes the display device 11 to display at least a part of the re-selected image and re-receives a designation of the second and third positions in the selected image from the user via the input device 12. The measuring instrument 100 then further acquires reference images associated respectively with the captured images and calculates, in reference to one of the reference images associated with the re-selected image, the three-dimensional position (coordinates) of a position on the subject, the latter position corresponding to the second position in the re-selected image, and the three-dimensional position (coordinates) of a position on the subject, the latter position corresponding to the third position in the re-selected image.

Since the control section 10 of the measuring instrument 100 serves as the image acquisition section 101, the first position receiving section 102, the image selecting section 103, and the second position receiving section 104 as described earlier under the headings, “1. Embodiment 1” and “2. Embodiment 2,” the user can accurately and easily designate a desired measurement point in an image. By re-selecting the selected image in accordance with the third position, the measuring instrument 100 enables the user to accurately and easily designate a plurality of measurement points in the image. By referring to the reference image associated with the re-selected image on the basis of information acquired in this manner on positions in the re-selected image (second position information and third position information), the measuring instrument 100 can accurately and in an error-reduced manner calculate the three-dimensional position (coordinates) of a position on the subject, the latter position corresponding to the second position in the re-selected image, and the three-dimensional position (coordinates) of a position on the subject, the latter position corresponding to the third position in the re-selected image.

### (2) Example of Measuring Process

The following will describe an example measuring process performed by the measuring instrument 100.

### Steps S0201 to S0204

Steps S0201 to S0204 have been described earlier under the heading, “5. Embodiment 5.” Description thereof is not repeated here.

### Steps S0101 to S0103

Steps S0101 to 50103 have been described earlier under the headings, “1. Embodiment 1” and “2. Embodiment 2.” Description thereof is not repeated here.

### Step S0104: Second Position Receiving Step

The second position receiving section 104 causes the display device 11 to display at least a part of the captured image as a selected image and receives a designation of a position (second position) in the selected image from the user via the input device 12. The second position receiving section 104 then further receives an input of a third position in the selected image via the input device 12, the third position differing from the second position.

Specifically, the second position receiving section 104 receives an input of the positions of two measurement points (second and third positions) via the input device 12 in order to calculate a distance between the two measurement points. The positions of measurement points are designated as described earlier under the heading, “1. Embodiment 1.” If the second measurement point (i.e., the third position) is designated, since the third position is designated in the selected image in which the second position is previously designated, images are simultaneously captured of the measurement points the distance between which is to be measured. That enables precise calculation of a distance between two points.

If images are captured, for example, with different exposure level settings in this situation, the two measurement points (i.e., the third position) are in either one of the following states. In the selected image in which the first measurement point (second position) is previously designated,

(1) There is occurring no grayscale saturation at the measurement point (third position) that the user wants to designate in a second time.

(2) Grayscale has saturated at the measurement point (third position) that the user wants to designate in a second time, and the measurement point thereby appears either black or white.

In state (1), the second position receiving section 104 needs only to receive an input of a position of the second measurement point (third position) while causing the display device 11 to display the selected image used in the designation of the first measurement point (second position). Meanwhile, in state (2), the image selecting section 103 re-selects a selected image, and the second position receiving section 104 re-receives an input of the positions of the first and second measurement points while causing the display device 11 to display the selected image which is re-selected. In other words, step S0104 includes substeps S01041 to S01041 described below.

### Substep S01041: Third Position Receiving Step

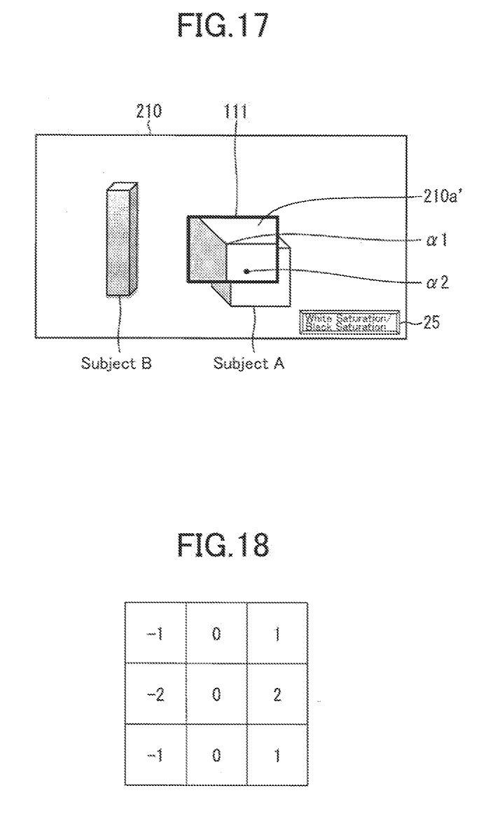

The second position receiving section 104 receives a designation of a third position in the selected image from the user via the input device 12, the third position differing from the second position. Referring to FIG. 17, the second position receiving section 104 receives a designation of the second measurement point α2 (third position) via the input device 12. In FIG. 17, α1 represents the first measurement point (second position).

### Substep S01042: Determining Step

The image selecting section 103 determines whether or not the selected image needs to be re-selected in accordance with the third position in the selected image. If the image selecting section 103 has determined that the selected image needs to be re-selected, the image selecting section 103 performs a step of re-selecting the selected image. On the other hand, if the image selecting section 103 has determined that the selected image does not need to be re-selected, the process of receiving the third position is ended.

The image selecting section 103, as an example, automatically determines, through the edge intensity of the scaled-up display image 111, whether or not there is occurring a grayscale saturation at the third position in the selected image. If the image selecting section 103 has determined that there is occurring no grayscale saturation at the third position in the selected image, the image selecting section 103 determines that the selected image does not need to be re-selected. On the other hand, if the image selecting section 103 has determined that there is occurring a grayscale saturation at the third position in the selected image, the image selecting section 103 determines that the selected image needs to be re-selected.

A description will now be given of how edge intensity is calculated. FIG. 18 is an example set of coefficients used in filtering for edge intensity detection. Nine numeric values are obtained by multiplying, by the coefficients shown in FIG. 18, the pixel values of the 3×3 pixels surrounding and including a pixel located where an edge is to be detected in an image. These nine values are then added up. Because edge intensity is presumed to be higher if the resultant numeric value has a larger absolute value, it can be determined whether the grayscale has reached saturation on the white end or the black end of the scale, by determining that edge intensity is extremely low when the resultant numeric value has an absolute value that is less than or equal to a predetermined threshold value.

The image selecting section 103 may determine, in accordance with a result of detection of a user operation, whether or not the selected image needs to be re-selected. For example, if there is occurring a grayscale saturation (either black or white) at the measurement point α2 in the selected image 210a′ used in the designation of the measurement point α1 as shown in FIG. 17, the user determines that the selected image needs to be re-selected and presses a determination button 25. On the other hand, if there is occurring no grayscale saturation at the measurement point α2 in the selected image 210a′ used in the designation of the measurement point α1, the user determines that the selected image does not need to be re-selected and does not press the determination button 25. In this situation, the image selecting section 103 determines, in accordance with a result of detection (or lack of detection) of a press of the determination button 25 by the user, whether or not the selected image needs to be re-selected.

### Substep S01043: Selected Image Re-Selecting Step

The image selecting section 103 re-selects one of the captured images as a selected image in accordance with the third position.

The image selecting section 103 may select one of the captured images as a selected image, for example by calculating the grayscale saturation level of a subarea including the third position for each captured image and selecting one of the captured images that has a minimum grayscale saturation level as a re-selected image. The “subarea including the third position” refers to a subarea of a captured image that includes a position (third-position-equivalent position) in the captured image corresponding to the third position. The size of the subarea is not limited in any particular manner and may be, for example, a rectangular region containing a predetermined number of pixels.

More specifically, if there is occurring a grayscale saturation at the measurement point α2 in the selected image 210a′ used in the designation of the measurement point α1 shown in FIG. 17, the image selecting section 103 calculates a contrast in a measurement-point-α1 region and in a measurement-point-α2 region for each captured image and selects captured images in which there is occurring no grayscale saturation at the two measurement points. It is preferable that an image in which contrast is high at both the measurement point α1 and the measurement point α2 be selected as a re-selected image from the captured images, because the position is clearly identified at which the similarity level used in block matching is a maximum and robustness increases in the calculation of a corresponding measuring point. An image in which contrast is high at both the measurement point α1 and the measurement point α2 may be selected, for example, by selecting an image having a maximum sum of the contrast levels at the two measurement points.

In addition, if the captured images have different focal point locations, an image is selected in which the image is in focus (focused) at both the measurement point α1 and the measurement point α2. Whether or not an image is in focus (focused) at a measurement point can be determined through contrast: the image is determined to be in better focus (better focused) at the measurement point if the surroundings of the measurement point have a higher contrast. Therefore, when the captured images have different focal point locations, an image in which contrast is high at both the measurement point α1 and the measurement point α2 may be similarly selected from the captured images.

### Substep S01044: Third Position Re-Receiving Step

The second position receiving section 104 causes the display device 11 to display at least a part of the re-selected image and re-receives a designation of a third position in the re-selected image from the user via the input device 12.

### Substep S01045: Second Position Re-Receiving Step

The second position receiving section 104 re-receives a designation of a second position in the re-selected image from the user via the input device 12.

This step enables a designation of the measurement point α1 as a second position and the measurement point α2 as a third position in the same selected image, which in turn enables measurement of a distance between the measurement point α1 and the measurement point α2.

### Step S0205: Reference image Acquisition Step

The measuring section 105 further acquires reference images associated respectively with the captured images and selects one of the reference images that is associated with the selected image (or the re-selected image).

### Step S0106: Three-dimensional Position Measuring Step

The measuring section 105 calculates depth information associated with the second position in reference to the reference image associated with the selected image (or the re-selected image) and calculates the three-dimensional position (coordinates) of a position (measurement point) on the subject, the latter position corresponding to the second position in the selected image, in reference to the second position information and the depth information. The measuring section 105 similarly calculates the three-dimensional position (coordinates) of a position (measurement point) on the subject, the latter position corresponding to the second position in the selected image. The measuring section 105 outputs results of the measurement for storage in a storage device (not shown) and/or for a display on the display device 11.

A distance can be calculated between two measurement points by calculating the relative positions of the two measurement points. The present embodiment has described calculation of a distance between two points. Alternatively, the number of measurement points may be increased, in which case the present embodiment is still applicable to calculation of, for example, a distance between a point and a straight line, a distance between two straight lines, and an area of a region linking a plurality of points as a result of measurement.

As described so far, a synthesized image is generated from a plurality of images captured under different image capturing conditions. The synthesized image is then used to let the user explore the image for a desired position for a measurement point A second position and a third position are designated in an image selected in accordance with a position (first position) found in the synthesized image or in a re-selected image re-selected in accordance with the third position. This configuration improves visibility of the entire image for the user to explore for a measurement point. Additionally, there is no need to acquire a high-quality synthesized image generated by considering the positional deviations of the subject. Even when the synthesized image is double vision, since the measurement point is designated in the selected image, it becomes possible to designate a desired position for a point by preventing double vision.

### (3) Variation Example of Measuring Instrument 100

The present embodiment has so far described the measuring instrument as incorporating the image capturing device. Alternatively, the image capturing device may be provided separately from the measuring instrument. For example, the image synthesized from the images captured by the above-described image capturing device may be stored in a storage device such as a RAM, a flash memory, or a HDD, so that the measuring instrument can read out an image from the storage device for a display on a display device. Alternatively, the captured images may be stored so that the measuring instrument can synthesize an image.

### Software Implementation

The control blocks of the position designation device 1 or of the measuring instrument 100 (particularly, the control section 10) may be implemented by logic circuits (hardware) fabricated, for example, in the form of an integrated circuit (IC chip) and may be implemented by software executed by a CPU (central processing unit).

In the latter form of implementation, the position designation device 1 or the measuring instrument 100 includes among others a CPU that executes instructions from programs or software by which various functions are implemented, a ROM (read-only memory) or like storage device (referred to as a “storage medium”) containing the programs and various data in a computer-readable (or CPU-readable) format, and a RAM (random access memory) into which the programs are loaded. The computer (or CPU) then retrieves and executes the programs contained in the storage medium, thereby achieving an object of the present invention. The storage medium may be a “non-transient, tangible medium” such as a tape, a disc, a card, a semiconductor memory, or programmable logic circuitry. The programs may be fed to the computer via any transmission medium (e.g., over a communications network or by broadcasting waves) that can transmit the programs. The present invention, in an aspect thereof, encompasses data signals on a carrier wave that are generated during electronic transmission of the programs.

### General Description

The present invention, in aspect 1 thereof, is directed to a position designation device (1) including: an image acquisition section (101) configured to acquire a plurality of captured images of the same subject and a synthesized image generated from the captured images; a first position receiving section (102) configured to cause a display device (11) to display the synthesized image and to receive an input of a first position in the synthesized image via an input device (12); an image selecting section (103) configured to select one of the captured images in accordance with the first position as a selected image; and a second position receiving section (104) configured to cause the display device (11) to display at least a part of the selected image and to receive an input of a second position in the selected image via the input device (12).

According to this configuration, the position designation device uses a synthesized image to let the user explore the image for a desired position for a measurement point. A measurement point is designated in an image selected in accordance with a position (first position) found in the synthesized image. Therefore, there is no need to acquire as high-quality synthesized image generated by considering the positional deviations of the subject. Even when the synthesized image is double vision, since the measurement point is designated in the selected image, there occurs no problem that the position of a measurement point cannot be accurately designated in a double-vision synthesized image. In addition, since there occurs no grayscale saturation near the first position in the image selected in accordance with the position (first position) found in the synthesized image, it is possible to designate a position in the selected image. Hence, the position designation device in accordance with aspect 1 of the present invention enables the user to easily and accurately designate a desired position for a measurement point in an image.

In aspect 2 of the present invention, the position designation device (measuring instrument 100) of aspect 1 may be configured to further include a measuring section (105) configured to acquire depth information associated with the selected image and to calculate three-dimensional coordinates of a position (measurement point) on a subject in reference to the depth information, the position corresponding to the second position in the selected image.

According to this configuration, the three-dimensional coordinates of a measurement point can be calculated.

In aspect 3 of the present invention, the position designation device (measuring instrument 100) of aspect 1 may be configured to further include a measuring section (105) configured to acquire a reference image associated with the selected image and to calculate three-dimensional coordinates of a position (measurement point) on a subject in reference to the reference image, the position corresponding to the second position in the selected image.

According to this configuration, the three-dimensional coordinates of a measurement point can be calculated.

In aspect 4 of the present invention, the position designation device (measuring instrument 100) of any one of aspects 1 to 3 may be configured to further include: an image capturing section (the base image capturing section 4) configured to capture a plurality of images as the captured images; and a synthesizing section (the synthesis processing section) configured to generate the synthesized image from the captured images.

According to this configuration, the three-dimensional coordinates of a measurement point can be calculated.

In aspect 5 of the present invention, the position designation device (measuring instrument 100) of any one of aspects 1 to 4 may be configured such that: the second position receiving section (third position receiving section) further receives an input of a third position in the selected image via the input device (12), the third position differing from the second position; the image selecting section (103) re-selects the selected image in accordance with the third position as a re-selected image; and the second position receiving section (third position receiving section) causes the display device (11) to display at least a part of the selected image re-selected by the image selecting section (re-selected image) and re-receives an input of the second and third positions in the selected image via the input device (12).

According to this configuration, the three-dimensional coordinates of a plurality of measurement points can be calculated.

In aspect 6 of the present invention, the position designation device (1) of any one of aspects 1 to 5 may be configured such that the image selecting section (103) calculates a grayscale saturation level of a subarea of each of the captured images, the subarea including the first position, and selects one of the captured images that has a minimum grayscale saturation level as a selected image.

According to this configuration, the position designation device selects, as the selected image, one of the captured images that has a minimum grayscale saturation level its accordance with a position (first position) designated by the user in the synthesized image, so that the user can designate a position (second position) in the selected image. Therefore, the user can accurately designate a position that the user wants to designate in an image.

In aspect 7 of the present invention, the position designation device (1) of any one of aspects 1 to 5 may be configured such that the image selecting section (103) calculates a focusing level of a subarea of each of the captured images, the subarea including the first position, and selects one of the captured images that has a maximum focusing level as a selected image.

According to this configuration, the position designation device selects, as the selected image, one of the captured images that has a maximum focusing level in accordance with a position (first position) designated by the user in the synthesized image, so that the user can designate a position (second position) in the selected image. Therefore, the user can accurately designate a position that the user wants to designate in an image.

The present invention, in aspect 8 thereof, is directed to a method of designating a position, the method including: the first position receiving step (step S0102) of receiving a designation of a first position in a synthesized image generated from a plurality of captured images of the same subject; the image selecting step (step S0103) of selecting one of the captured images in accordance with the first position received in the receiving step (step S0102) as a selected image; and the second position receiving step (step S0104) of receiving a designation of a second position in the selected image selected in the image selecting step (step S0103).

According to this configuration, the user can easily and accurately designate a desired position for a measurement point in an image.

The position designation device of any aspect of the present invention may be implemented on a computer, in which case the present invention encompasses a control program (position designation program) that, for the position designation device, causes a computer to implement the position designation device by causing the computer to operate as the various units (software elements) of the position designation device and also encompasses a computer-readable storage medium containing the position designation program.

The present invention is not limited to the description of the embodiments above and may be altered within the scope of the claims. Embodiments based on a proper combination of technical means disclosed in different embodiments are encompassed in the technical scope of the present invention. Furthermore, a new technological feature may be created by combining different technological means disclosed in the embodiments.

### CROSS REFERENCE TO RELATED APPLICATIONS

The present application claims the benefit of priority to Japanese Patent Application, Tokugan, No. 2016-156917, filed on Aug. 9, 2016, the entire contents of which are incorporated herein by reference.

### REFERENCE SIGNS LIST

1 Position Designation Device
4 Base image Capturing Section
5 Control Section
6 Reference image Capturing Section
7 Synthesis Processing Section
8 Image Capturing Device
10 Control Section
11 Display Device
12 Input Device
100 Measuring Instrument
101 image Acquisition Section
102 First Position Receiving Section
103 Image Selecting Section
104 Second Position Receiving Section
105 Measuring Section

1. A position designation device comprising:
a first position receiving section configured to receive an input of a first position in a synthesized image generated from a plurality of captured images;
an image selecting section configured to select one of the captured images in accordance with the first position as a selected image; and
a second position receiving section configured to receive an input of a second position in the selected image.

2. The position designation device according to claim 1, wherein the captured images have different exposure levels.

3. The position designation device according to claim 1, wherein the image selecting section selects one of the captured images as a selected image based on a grayscale saturation level of a subarea of each of the captured images, the subarea including the first position.

4. The position designation device according to claim 1, wherein the image selecting section calculates a grayscale saturation level of a subarea of each of the captured images, the subarea including the first position, and selects one of the captured images that has a minimum grayscale saturation level as a selected image.

5. The position designation device according to claim 1, wherein the captured images have different focal point locations.

6. The position designation device according to claim 1, wherein the image selecting section selects one of the captured images as a selected image based on a focusing level of a subarea of each of the captured images, the subarea including the first position.

7. The position designation device according to claim 1, wherein the image selecting section calculates a focusing level of a subarea of each of the captured images, the subarea including the first position, and selects one of the captured images that has a maximum focusing level as a selected image.

8. The position designation device according to claim 1, further comprising a measuring section configured to acquire depth information associated with the selected image and to calculate three-dimensional coordinates of a position on a subject in reference to the depth information, the position corresponding to the second position in the selected image.

9. The position designation device according to claim 1, further comprising a measuring section configured to acquire a reference image associated with the selected image and to calculate three-dimensional coordinates of a position on a subject in reference to the reference image, the position corresponding to the second position in the selected image.

10. The position designation device according to claim 1, further comprising:
an image capturing section configured to capture a plurality of images as the captured images;
and a synthesizing section configured to generate the synthesized image from the captured images.

11. The position designation device according to claim 1, wherein:
the second position receiving section further receives an input of a third position in the selected image, the third position differing from the second position;
the image selecting section re-selects the selected image in accordance with the third position; and
the second position receiving section re-receives an input of the second and third positions in the selected image via the input device.

12. The position designation device according to claim 1, further comprising a display device and an input device.

13. A method of designating a position, the method comprising:
the first position receiving step of receiving a designation of a first position in a synthesized image generated from a plurality of captured images;
the image selecting step of selecting one of the captured images in accordance with the first position received in the receiving step as a selected image; and
the second position receiving step of receiving a designation of a second position in the selected image.

14. A storage medium containing a program causing a computer to operate as: a first position receiving section configured to receive an input of a first position in a synthesized image generated from a plurality of captured images; an image selecting section configured to select one of the captured images in accordance with the first position as a selected image; and a second position receiving section configured to receive an input of a second position in the selected image.
